(19) United States
(12) Patent Application Publication
(10) Pub. No.: US 2026/0071052 A1
(43) Pub. Date: Mar. 12, 2026

(54) Capsule Filled with Polymer Additives, Polymer-Additive Pods, and Methods for Using Them in a Polymer-Compounding Process

(71) Applicant: Dover Chemical Corporation, Dover, OH (US)

(72) Inventors: Michael Jakupca, Canton, OH (US); Marc Nolen, Dover, OH (US); Jacob Lance, Dover, OH (US)

(73) Assignee: Dover Chemical Corporation, Dover, OH (US)

(21) Appl. No.: 19/322,025

(22) Filed: Sep. 8, 2025

Related U.S. Application Data
(60) Provisional application No. 63/691,808, filed on Sep. 6, 2024.

(51) Int. Cl. C08K 5/527; C08K 5/524; C08K 9/10

(52) U.S. Cl. CPC C08K 5/527; C08K 5/524; C08K 9/10

(57) ABSTRACT

A capsule having: a capsule shell having a capsule-shell composition; the capsule shell having at least one interior surface and at least one exterior surface; the at least one interior surface being a boundary of a first cavity within the capsule; the first cavity having a first-cavity total volume of space; a polymer-additive fill composition that occupies a portion of the first-cavity total volume of space; the polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; and the polymer-additive fill composition being a different composition than the capsule-shell composition.

### CROSS-REFERENCE TO RELATED APPLICATIONS

This patent application claims priority to U.S. provisional patent application 63/691,808 titled, “Capsule Filled with Polymer Additives, Polymer-Additive Pods, and Methods for Using Them in a Polymer-Compounding Process.” The subject matter of U.S. provisional patent application 63/691,808 is incorporated into this application by reference.

### BACKGROUND OF THE INVENTION

In polymer compounding, using a polymer additive(s) in a polymer-compounding process is well known. For example, polymer additives are commonly introduced into a polymer compounding process, after introduction compounding then occurs (wherein one or more polymer additives are compounded into a polymer composition), and then the resulting compounded composition is often pelletized for future use in a manufacturing process or a subsequent polymer-compounding process.

Introducing a polymer additive(s) into a polymer-compounding process is achievable using a variety of currently known methods, and selecting any specific method of polymer-additive introduction depends heavily on whether a particular polymer additive is a solid-phase or liquid-phase additive. For example, in the use of single-screw compounding extruders, a solid-phase polymer additive is typically introduced directly into an extruder's feed throat in either a powder or pelletized concentrate form. But liquid-phase polymer additives are often introduced into a single-screw compounding extruder via injection into the single-screw extruder's barrel at a location that is downstream from the feed throat.

There remains a need for additional methods of introducing polymer additives into polymer-compounding processes in both efficient and commercially viable ways.

### BRIEF SUMMARY OF THE INVENTION

A capsule having: a capsule shell having a capsule-shell composition; the capsule shell having at least one interior surface and at least one exterior surface; the at least one interior surface being a boundary of a first cavity within the capsule; the first cavity having a first-cavity total volume of space; a polymer-additive fill composition that occupies a portion of the first-cavity total volume of space; the polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; and the polymer-additive fill composition being a different composition than the capsule-shell composition.

A capsule having: a capsule shell having a capsule-shell composition; the capsule shell having a first interior surface, a second interior surface, and at least one exterior surface; the first interior surface being a boundary of a first cavity within the capsule; the second interior surface being a boundary of a second cavity within the capsule; the first cavity having a first-cavity total volume of space; the second cavity having a second-cavity total volume of space; a first polymer-additive fill composition that occupies at least a portion of the first-cavity total volume of space; a second polymer-additive fill composition that occupies at least a portion of the second-cavity total volume of space; the first polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; the second polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; the first polymer-additive fill composition being a different polymer additive than the second polymer-additive fill composition; and the first polymer-additive fill composition and the second polymer-additive fill composition being different compositions than the capsule-shell composition.

A polymer-additive pod having: a pod skin that is at least one polymeric film manufactured from a polymeric-film composition; the pod skin having at least one interior surface and at least one exterior surface; the pod-skin interior surface being a boundary of an internal first cavity that is enclosed within the polymer-additive pod; the first cavity having a total volume of space; a polymer-additive fill composition that occupies a portion of the first-cavity total volume of space; the polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; and the polymer-additive fill composition being a different composition than the polymeric-film composition.

Embodiments are generally directed to an encapsulated polymer additive(s), e.g., a capsule having a capsule shell and at least one interior cavity that is filled with a polymer additive. In addition to capsule-related embodiments and pod-related embodiments, related methods are directed to one or more polymer-additive-filled capsules or polymer-additive-filled pods being introduced into a polymer-compounding process; in these method embodiments, polymer-additive-filled capsules or polymer-additive-filled pods are used as vehicles for introducing a polymer additive(s) into a polymer-compounding process.

Notably, these polymer-additive-filled-capsule embodiments and polymer-additive-filled-pod embodiments are distinct from known pelletized polymer-additive concentrates that result from a polymer additive(s) being compounded into a carrier resin and then pelletizing the resulting compounded composition for future use in a polymer-compounding process.

It is at least a polymer-additive-filled capsule embodiment's: i) capsule shell, ii) inner cavity(s), and iii) polymer additive occupying a volume of space within the inner cavity, that provides a basis for differentiating the polymer-additive-filled capsule embodiments from known pelletized additive concentrates. And it is at least a polymer-additive-filled pod embodiment's: i) pod skin, ii) internal cavity(s), and iii) polymer additive occupying a volume of space within the internal cavity(s), that provides a basis for differentiating the polymer-additive-filled capsule embodiments and polymer-additive-filled pod embodiments from known pelletized additive concentrates.

Advantages of using polymer-additive-filled capsules or polymer-additive-filled pods include:
a. polymer-additive-filled capsules or polymer-additive-filled pods allow liquid additives to be loaded using solid feeding equipment-solid feeders being common in production facilities;
b. polymer-additive-filled capsules or polymer-additive-filled pods protect encapsulated additives from humidity and moisture thereby preventing hydrolysis;
c. polymer-additive-filled capsules or polymer-additive-filled pods protect additives with a low melting point from agglomerating in a warehouse during storage;
d. polymer-additive-filled capsules or polymer-additive-filled pods protect additives with a low melting point from sticking to the extruder feed throat while charging the additive into an extruder-which allows for improved dosing accuracy and reduces down time to clean the equipment; and
e. polymer-additive-filled capsules or polymer-additive-filled pods improve industrial hygiene by reducing dust from solid additives.

### BRIEF DESCRIPTION OF THE SEVERAL VIEWS OF THE DRAWING(S)

FIG. 1 is a side-perspective view of an embodiment.

FIG. 2 is an exploded side-perspective view of an embodiment.

FIG. 3 is a side view of an embodiment.

FIG. 3A is a cross-sectional view of an embodiment.

FIG. 4 is a side-perspective view of an embodiment.

FIG. 5 is a side-perspective view of an embodiment.

FIG. 6 is a side-perspective view of an embodiment.

FIG. 7 is an exploded side-perspective view of an embodiment.

FIG. 8 is a side view of an embodiment.

FIG. 8A is a cross-sectional view of an embodiment.

FIG. 9 is a side-perspective view of an embodiment.

FIG. 10 is a side-perspective view of an embodiment.

FIG. 11 is a side-perspective view of an embodiment.

FIG. 12 is a side view of an embodiment.

FIG. 12A is a cross-sectional view of an embodiment.

FIG. 13 is a side-perspective view of an embodiment.

FIG. 14 is a side-perspective view of an embodiment.

FIG. 15 is a side-perspective view of an embodiment.

FIG. 16 is a side view of an embodiment.

FIG. 16A is a cross-sectional view of an embodiment.

FIG. 17 is an exploded side-perspective view of an embodiment.

FIG. 18 is a side-perspective view of an embodiment.

FIG. 19 is a side-perspective view of an embodiment.

FIG. 20 is a side-perspective view of an embodiment.

FIG. 21 is a side-perspective view of an embodiment.

FIG. 22 is a side-perspective view of an embodiment.

### DETAILED DESCRIPTION OF THE INVENTION

Embodiments are generally directed to a capsule containing at least one polymer additive, and more specifically-a capsule having a capsule shell, at least one inner cavity, and at least one polymer additive occupying a volume of space within the at least one inner cavity. Additional embodiments are directed to introducing one or more polymer-additive-filled capsules into a polymer-compounding process.

Other embodiments are directed to a polymer-additive pod that can be understood to be a sealed pouch manufactured from a polymeric film, wherein the sealed pouch has at least one internal first cavity that is filled with a polymer-additive fill composition. Additional embodiments are directed to introducing one or more polymer-additive pods into a polymer-compounding process.

### Two-Piece Hard Shell Configuration

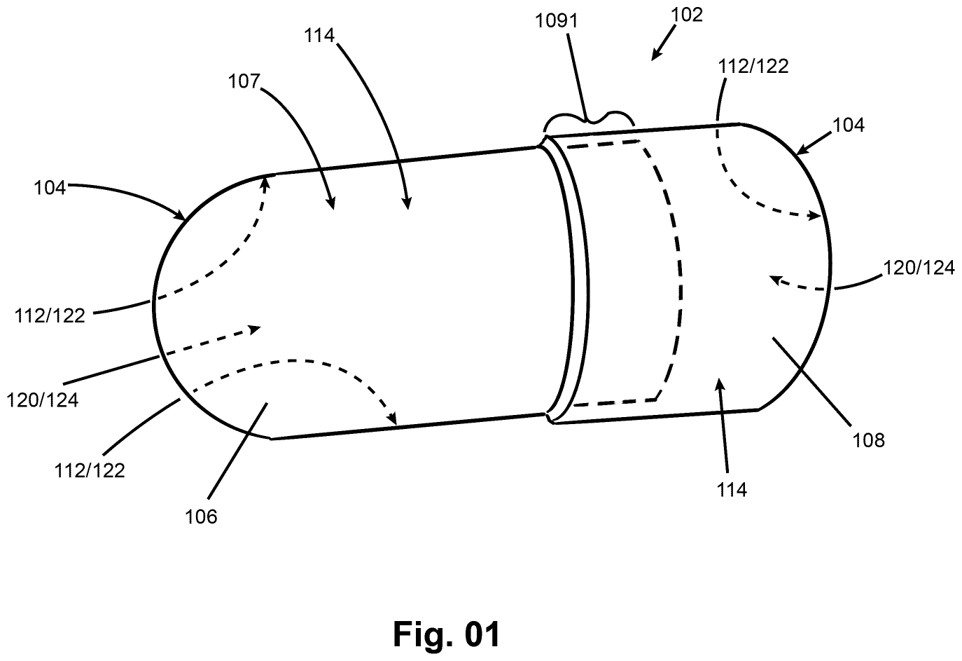

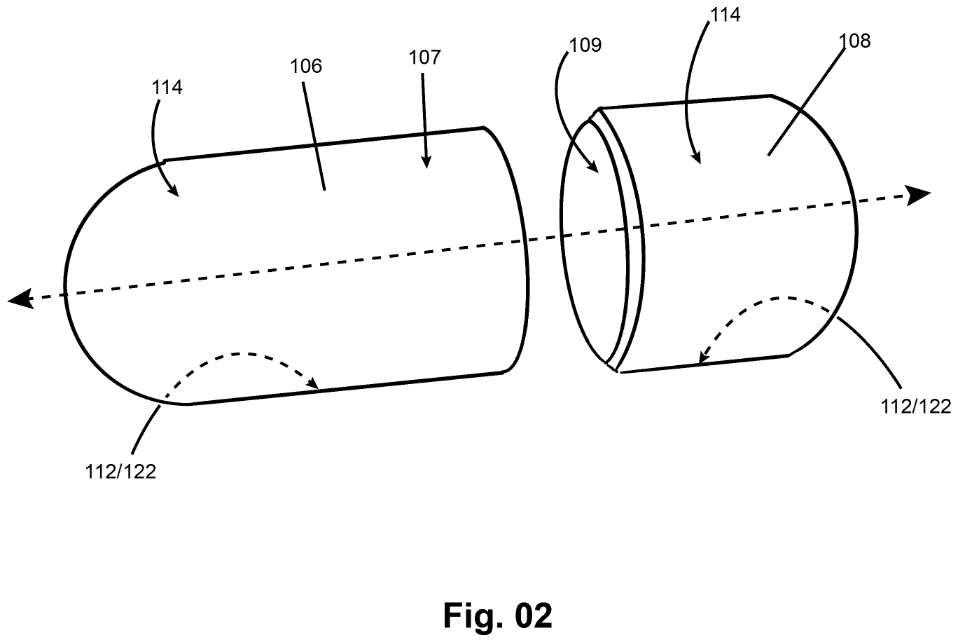

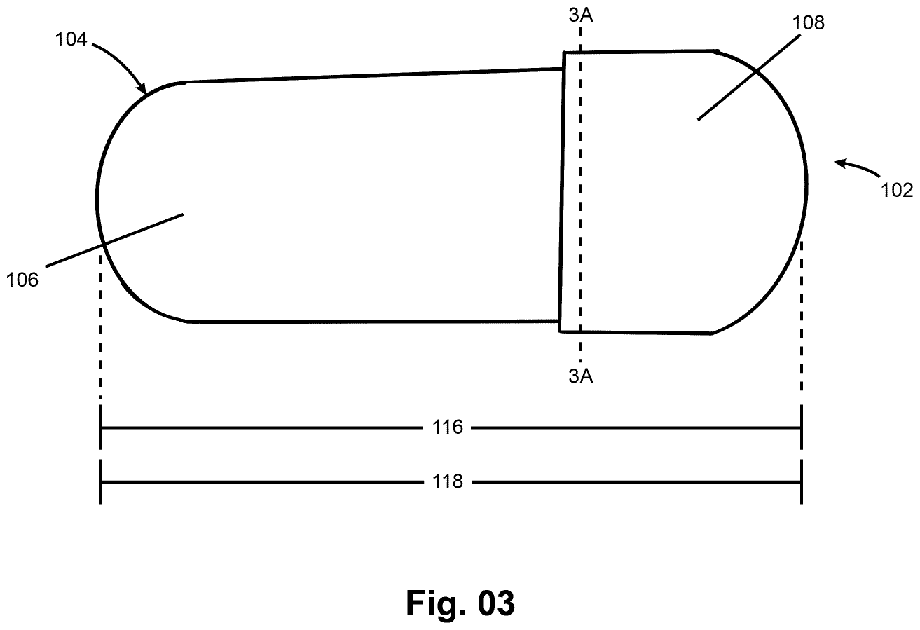

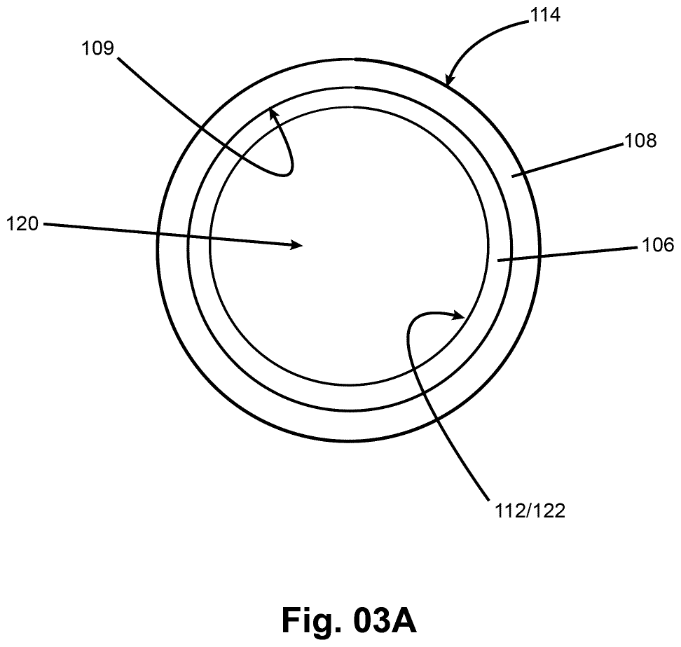

Regarding capsule embodiments that employ a two-piece hard-shell configuration and one internal cavity, as shown in FIGS. 1-5, two-piece hard-shell capsule configurations include capsule 102 having capsule shell 104 that is made up of two capsule-shell portions-capsule-shell body portion 106 and capsule-shell cap portion 108. In embodiments, a distel-end section of capsule-shell body portion 106 is inserted into capsule-shell cap portion 108; to the depth or degree that distel-end section of capsule-shell body portion 106 is inserted into capsule-shell cap portion 108, their respectively adjacent surfaces 107, 109, i.e., capsule-shell body-portion exterior surface 107 and capsule-shell cap-portion interior surface 109, are in contact with one another. In embodiments, these two surfaces are pressure-fit, mechanically attached, or sealed together and are thereby fixedly attached to one another. Methods known in the art can be used to fixedly attach capsule-shell body portion 106 to capsule-shell cap portion 108, e.g., a mechanical-attachment mechanism that fixedly attaches or secures capsule-shell body-portion exterior surface 107 to capsule-shell cap-portion interior surface 109, thereby fixing capsule-shell body portion 106 and capsule-shell cap portion 109 in their relative positions to each other. In additional embodiments (not shown in the Figs.), capsule-shell body portion 106 and capsule-shell cap portion 108 respectively have male-and-female interlocking shell configurations that interlock or snap into position with one another at a predetermined insertion depth of capsule-shell body portion 108 into first capsule-shell cap portion 108—thereby mechanically fixing their relative positions to one another. Furthermore, a pressure-fit, mechanically attached, or scaled capsule configuration: i) prevents contaminants from entering into first cavity 120, ii) prevents fill composition 140, i.e., polymer additive composition 150, from exiting first cavity 120, and iii) maintains the integrity of the capsule configuration as a single unit; stated differently, the fixed attachment of capsule-shell body portion 106 to capsule-shell cap portion 108 prevents the assembled capsule from separating during transport and commercial use. In embodiments, capsule-shell interior surface 112 is a boundary of first cavity 120.

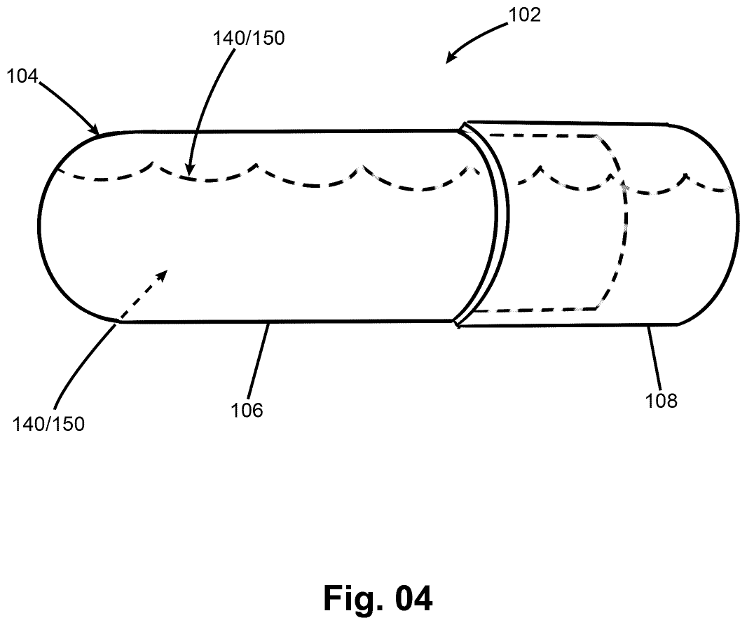

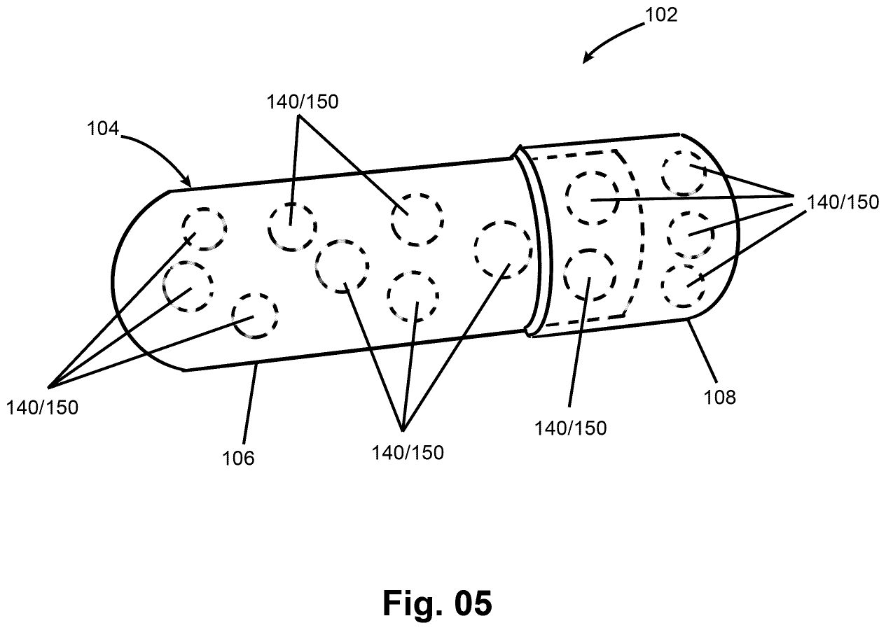

As shown in FIG. 4, capsule 102 having a two-piece hard-shell configuration, can be filled with a fill material 140 that is a liquid, i.e., a liquid polymer additive 150, or as shown in FIG. 5, capsule 102 having a two-piece hard-shell configuration, can be filled with a fill material 140 that is a solid, i.e., a solid polymer additive 150.

The amount of liquid or solid polymer additive 150 within capsule first cavity 120 can be determined by a person of ordinary skill in the art without having to exercise undue experimentation and will necessarily be a function of a capsule's first-cavity total volume of space 124.

In embodiments, capsule 102 has a first-cavity total volume of space 124 ranging from 1 to 100 milliliters. In embodiments, capsule 102 has a first-cavity total volume of space 124 ranging from 1 to 50 milliliters. In embodiments, capsule 102 has a first-cavity total volume of space 124 ranging from 1 to 10 milliliters. In embodiments, capsule 102 has a first-cavity total volume of space 124 ranging from 1 to 5 milliliters. In embodiments, capsule 102 has a first-cavity total volume of space 124 ranging from 0.1 to 2 milliliters. In embodiments, capsule 102 has a first-cavity total volume of space 124 that is less than 5 milliliters.

In embodiments, capsule 102 has longitudinal length 116 that is less than 100 centimeters. In embodiments, capsule 102 has longitudinal length 116 that is less than 20 centimeters. In embodiments, capsule 102 has longitudinal length 116 that is less than 10 centimeters. In embodiments, capsule 102 has longitudinal length 116 that is less than 5 centimeters. In embodiments, the greatest characteristic linear dimension 118 is longitudinal length 116, and the greatest characteristic linear dimension 118 is the greatest linear length that can be measured as a characteristic dimension of capsule 102.

### First Embodiment of a Three-Piece Hard-Shell Configuration

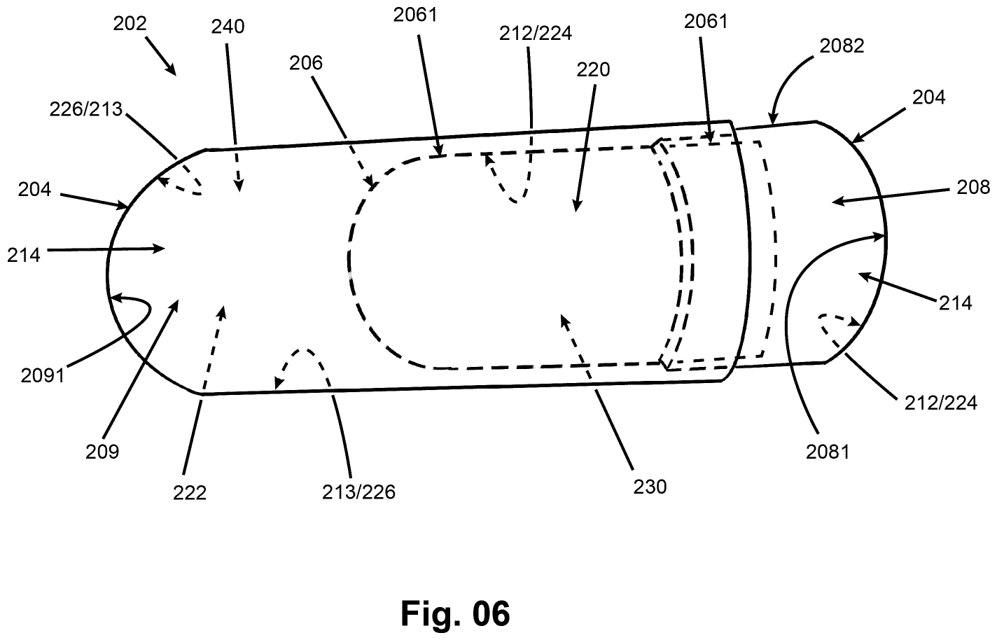

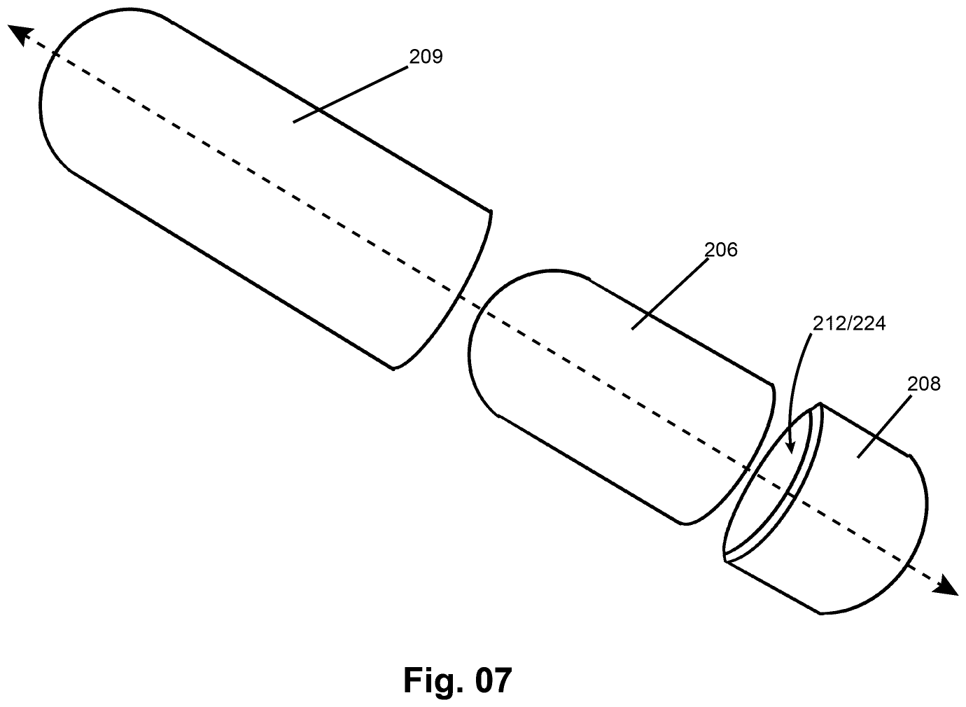

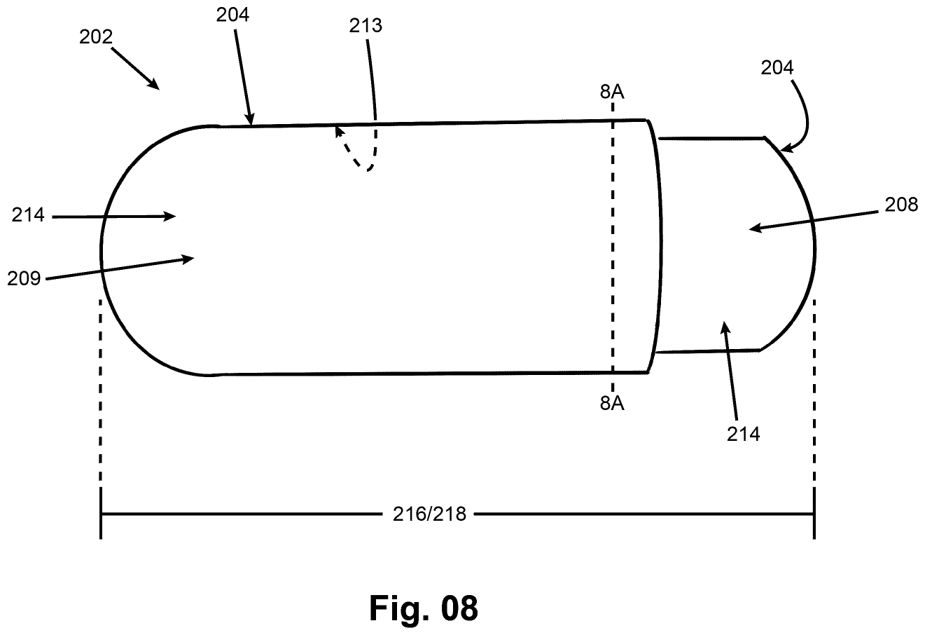

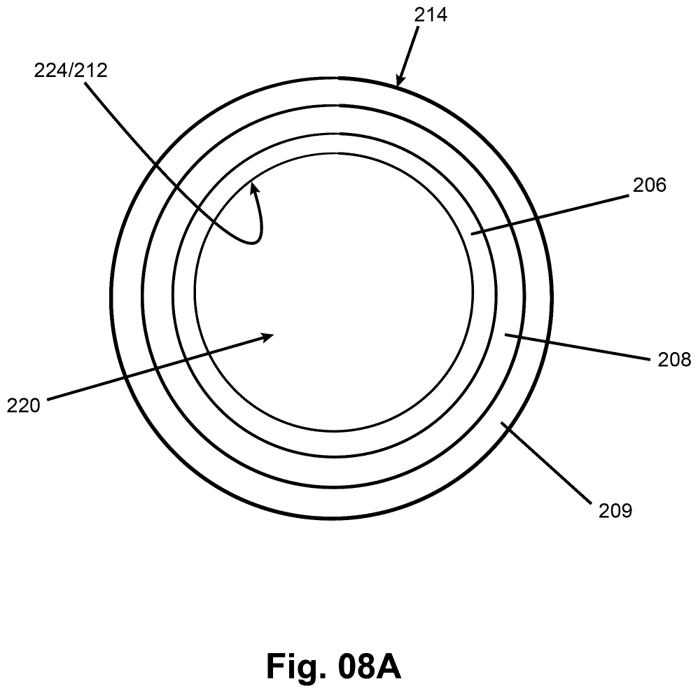

With reference to FIGS. 6-10, capsule 202 embodiments that employ a three-piece hard-shell configuration having two internal cavities, i.e., first cavity 220 and second cavity 222, as shown in FIGS. 6-10, in embodiments, three-piece hard-shell configurations can be understood to include similar, if not an identical, two-piece configuration as the above-described two-piece hard-shell capsule configuration 102 in combination with an additional second capsule-shell cap portion 209. And it is this second capsule-shell cap portion 209 that forms a boundary that defines second cavity 222.

A distel-end section of capsule-shell body portion 206 inserted into capsule-shell first cap portion 208; to the depth or degree that distel-end section of capsule-shell body portion 206 is inserted into capsule-shell first cap portion 208, their respectively adjacent surfaces, i.e., capsule-shell body-portion exterior surface 2061 and capsule-shell first cap-portion interior surface 2081, are in contact with one another. In embodiments, these two surfaces are pressure-fit, mechanically attached, or sealed together and are thereby fixedly attached to one another. Methods known in the art can be used to fixedly attach capsule-shell body portion 206 to capsule-shell first cap portion 208, e.g., a mechanical-attachment mechanism that fixedly attaches or secures capsule-shell body-portion exterior surface 2061 to capsule-shell first cap-portion interior surface 2081, thereby fixing capsule-shell body portion 206 and capsule-shell first cap portion 208 in their relative positions to each other. In additional embodiments (not shown in the Figs.), capsule-shell body portion 206 and capsule-shell first cap portion 208 respectively have male-and-female interlocking shell configurations that interlock or snap into position with one another at a predetermined insertion depth of capsule-shell body portion 206 into capsule-shell first cap portion 208—thereby mechanically fixing their relative positions to one another. Furthermore, a pressure-fit, mechanically attached, or sealed capsule configuration: i) prevents contaminants from entering into first cavity 220, ii) prevents first fill composition 250/270, i.e., a polymer additive composition, from exiting first cavity 220, and iii) maintains the fixed attachment of capsule-shell body portion 206 to capsule-shell first cap portion 208.

To complete the three-piece capsule-shell configuration, in addition to the immediately above-described fixed assembly of capsule-shell body portion 206 to capsule-shell first cap portion 208, capsule-shell second cap portion 209 overlaps a distal end of capsule-shell first cap portion 208; to the depth or degree that distel-end section of capsule-shell first cap portion 208 is inserted into capsule-shell second cap portion 209, their respectively adjacent surfaces, i.e., capsule-shell first-cap-portion exterior surface 2082 and capsule-shell second-cap-portion interior surface 2091, are in contact with one another. In embodiments these two surfaces 2082, 2091 are sealed and thereby fixedly attached to one another, and methods known in the art can be used to create a seal between these two surfaces, i.e., a seal between capsule-shell first cap-portion exterior surface 2082 and capsule-shell second cap-portion interior surface 2091, thereby fixing capsule-shell first cap portion 208 and capsule-shell second cap portion 209 in their relative positions to each other. In additional embodiments (not shown in the Figs.), capsule-shell first cap portion 208 and capsule-shell second cap portion 209 are mechanically configured to interlock or snap into position with one another at a predetermined insertion depth of capsule-shell first cap portion 208 into capsule-shell second cap portion 209 and thereby fixedly attach capsule-shell first cap portion 208 to capsule-shell second cap portion 209. Furthermore, the seal, pressure fit, or interlocking mechanical attachment: i) prevents contaminants from entering into second cavity 222, ii) prevents second fill composition 260/280, e.g., a polymer additive composition, from exiting second cavity 222, and iii) maintains the integrity of the overall capsule configuration as a single unit; in other words, the seal, pressure fit, or mechanical attachment mechanism prevents capsule-shell first cap portion 208 from separating from capsule-shell second cap portion 209.

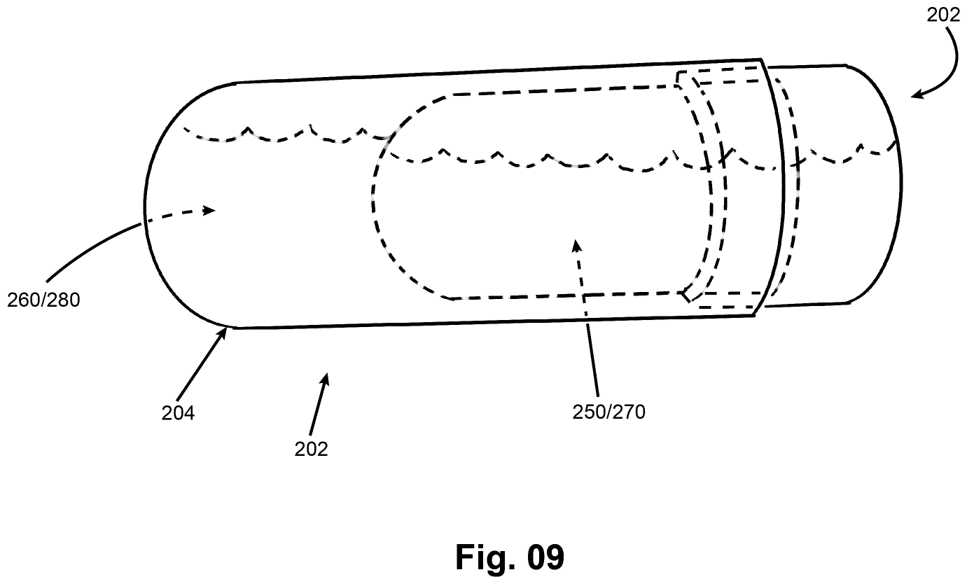

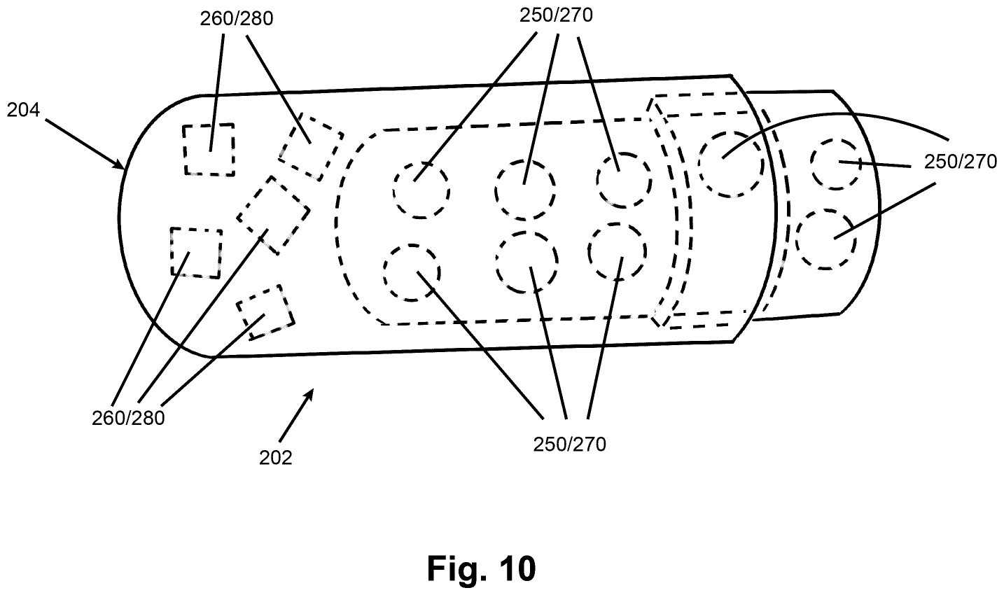

As shown in FIG. 9, capsule 202 having a three-piece hard-shell configuration and two inner cavities 220, 222 can have first cavity 220 filled with a first fill material 250 that is a liquid, e.g., a first liquid polymer additive 270, and second cavity 222 can be filled with a second fill material 260 that is a liquid, e.g., a second liquid polymer additive 280. Also, as shown in FIG. 10, capsule 202 having a three-piece hard-shell configuration, can have first cavity 220 filled with a first solid fill material 250, e.g., a first solid polymer additive 270, and second cavity 222 filled with a second solid fill material 260, e.g., a second solid polymer additive 280. In still other embodiments, capsule 202 having a three-piece hard-shell configuration can have first inner cavity 220 filled with a liquid polymer additive 270 and second cavity 222 filled with a solid polymer additive 280.

Amounts of fill compositions, i.e., first fill composition 250 and second fill composition 260 that are respectively first-fill-composition polymer additive 270 and second-fill-composition polymer additive 280, within each of the two inner cavities 220, 222 can be determined by persons of ordinary skill in the art without having to exercise undue experimentation and will necessarily be a function of each inner cavity's 220, 222 respective total volume of space.

In embodiments, capsule 202 has a first-cavity total volume of space 230 ranging from 1 to 100 milliliters and a second-cavity total volume of space 240 ranging from 1 to 100 milliliters. In embodiments, capsule 202 has a first-cavity total volume of space 230 ranging from 1 to 50 milliliters and a second-cavity total volume of space 240 ranging from 1 to 50 milliliters. In embodiments, capsule 202 has a first-cavity total volume of space 230 ranging from 1 to 10 milliliters and a second-cavity total volume of space 240 ranging from 1 to 10 milliliters. In embodiments, capsule 202 has a first-cavity total volume of space 230 ranging from 1 to 5 milliliters and a second-cavity total volume of space 240 ranging from 1 to 5 milliliters. In embodiments, capsule 202 has a first-cavity total volume of space 230 ranging from 0.1 to 2 milliliters and a second-cavity total volume of space 240 ranging from 0.1 to 2 milliliters. In embodiments, capsule 202 has a first-cavity total volume of space 230 that is less than 5 milliliters and a second-cavity total volume of space 240 that is less than 5 milliliters.

In embodiments, capsule 202 has longitudinal length 216 that is less than 100 centimeters. In embodiments, capsule 202 has longitudinal length 216 that is less than 20 centimeters. In embodiments, capsule 202 has longitudinal length 216 that is less than 10 centimeters. In embodiments, capsule 202 has longitudinal length 216 that is less than 5 centimeters. In embodiments, that greatest characteristic linear dimension 218 is longitudinal length 216, and the greatest characteristic linear dimension 218 of capsule 202 is the greatest linear length that can be measured as a characteristic dimension of capsule 202.

### Second Embodiment of a Three-Piece Hard-Shell Configuration

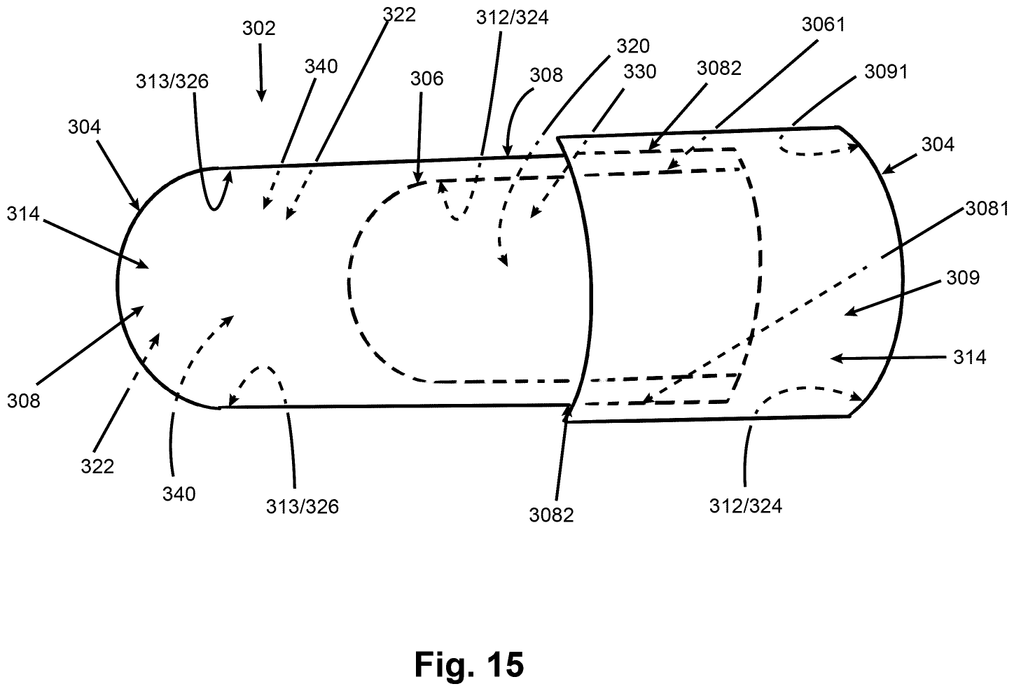

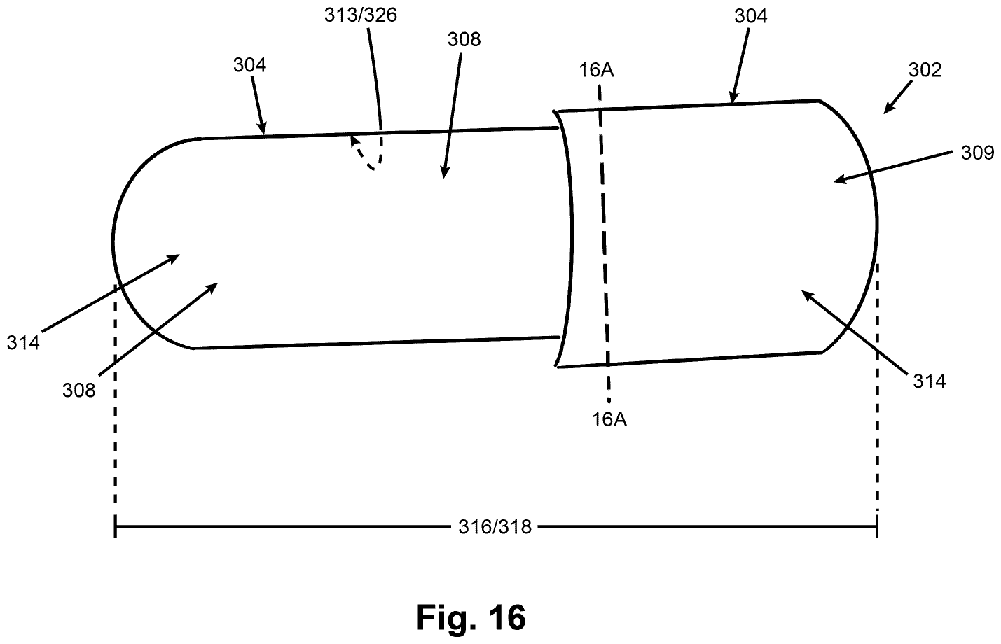

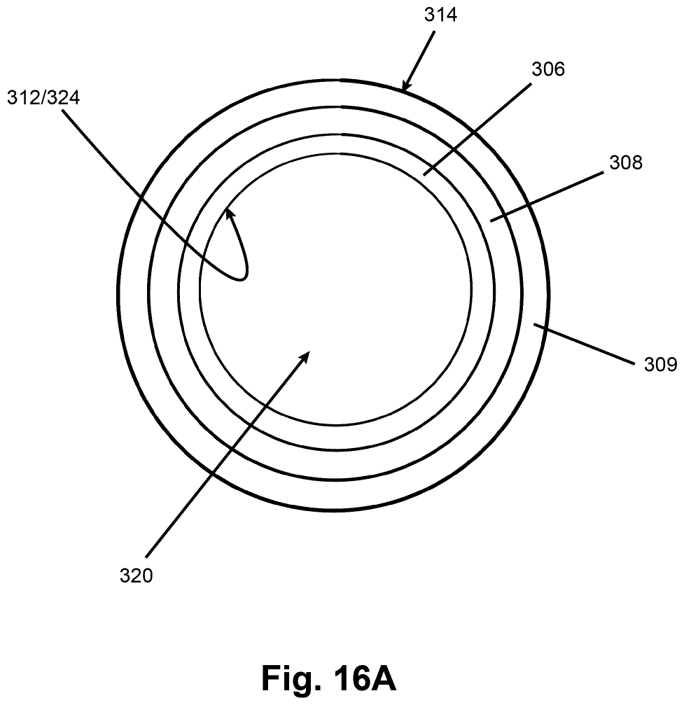

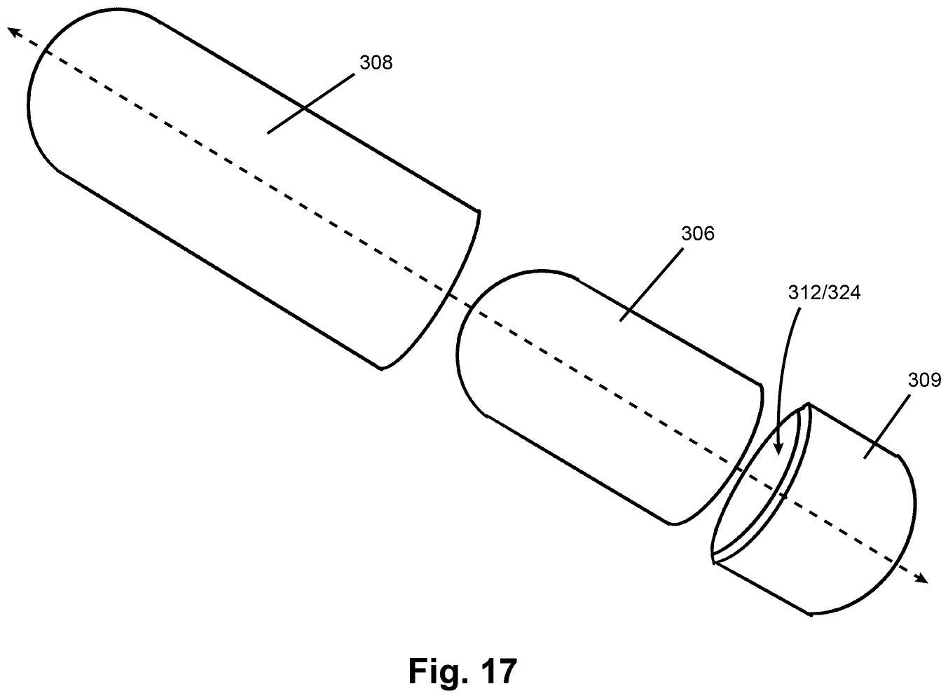

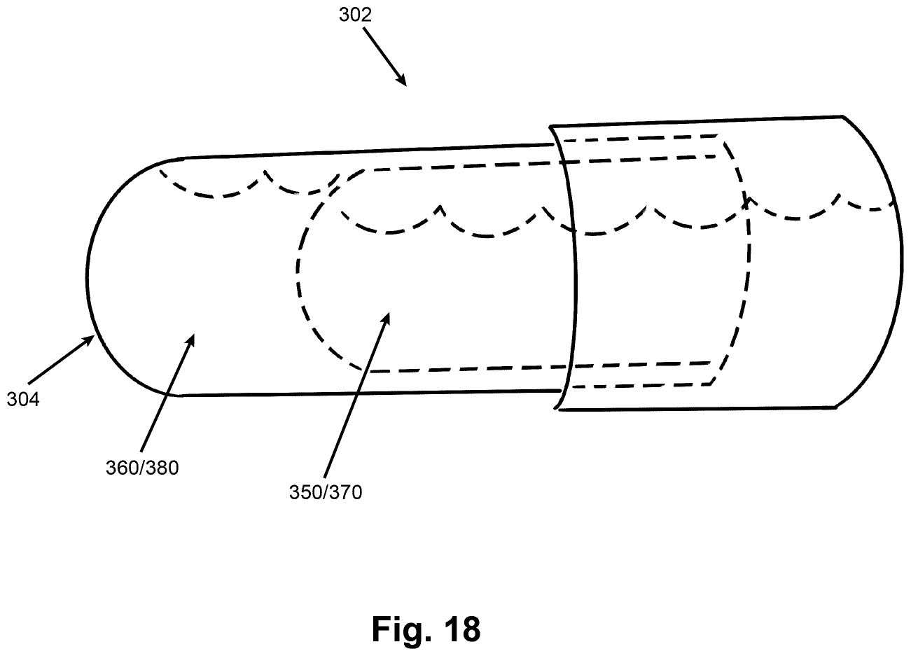

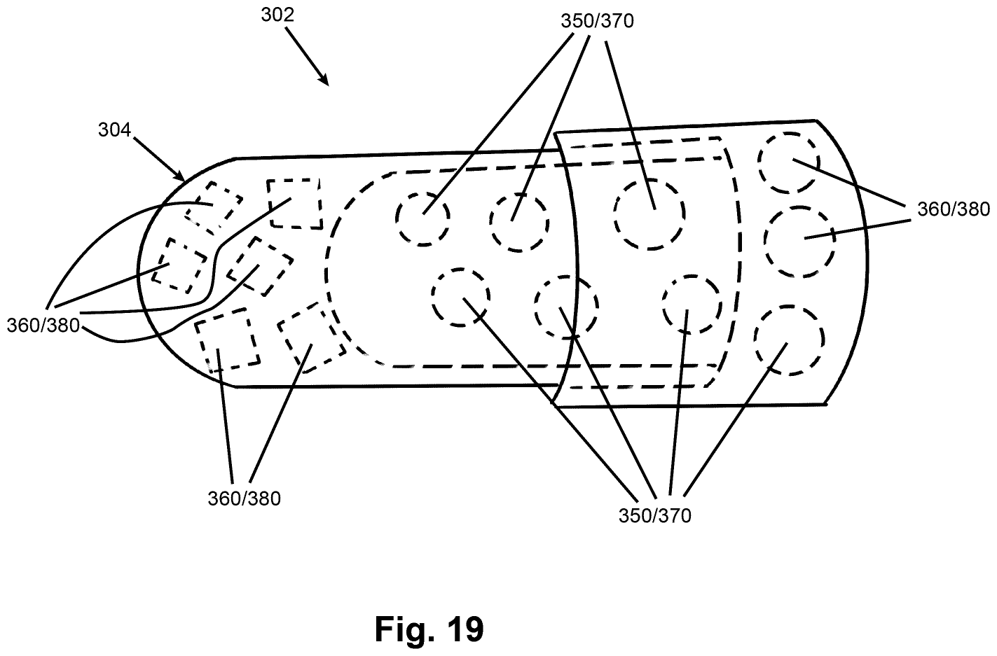

With reference to FIGS. 15-19, an additional useful three-piece hard-shell capsule configurations 302 having two internal cavities, i.e., internal cavities 320, 322 are provided.

These additional three-piece hard-shell capsule configurations 302 can be understood to include capsule-shell first body portion 306, capsule-shell second body portion 308, and capsule-shell cap portion 309, first cavity 320, second cavity 322, first polymer additive fill composition 350/370, and second polymer additive fill composition 360/380.

Capsule-shell first body portion 306 is inserted into capsule-shell second body portion 308; to the depth or degree that capsule-shell first body portion 306 is inserted into capsule-shell second body portion 308, their respectively adjacent surfaces, i.e., capsule-shell first-body-portion exterior surface 3061 and capsule-shell second-body-portion interior surface 3081, are in contact with one another. In embodiments, these two surfaces 3061, 3081 are pressure-fit, mechanically attached, or sealed together and are thereby fixedly attached to one another. Methods known in the art can be used to fixedly attach capsule-shell first body portion 306 to capsule-shell second body portion 308, e.g., a mechanical-attachment mechanism that fixedly attaches or secures capsule-shell first-body-portion exterior surface 3061 to capsule-shell second-body-portion interior surface 3081, thereby fixing capsule-shell first body portion 306 and capsule-shell second body portion 308 in their relative positions to each other. In additional embodiments (not shown in the Figs.), capsule-shell first body portion 306 and capsule-shell second body portion 308 respectively have male-and-female interlocking shell configurations that interlock or snap into position with one another at a predetermined insertion depth of capsule-shell first body portion 306 into capsule-shell second body portion 308—thereby mechanically fixing their relative positions to one another.

Furthermore, a pressure-fit, mechanically attached, or sealed capsule configuration: i) prevents contaminants from entering into first cavity 320, ii) prevents fill composition 350, i.e., a polymer additive composition 370, from exiting first cavity 320, and iii) prevents the fixed attachment of capsule-shell first body portion 306 to capsule-shell second body portion 308 from separating during transport and commercial use.

In addition to the immediately above-described fixed assembly of capsule-shell first body portion 306 to capsule-shell second body portion 308, capsule-shell cap portion 309 overlaps a distal end of capsule-shell second body portion 308; to the depth or degree that distel end of capsule-shell second body portion 308 is inserted into capsule-shell cap portion 309, their respectively adjacent surfaces, i.e., capsule-shell second-body-portion exterior surface 3082 and capsule-shell cap-portion interior surface 3091, are in contact with one another. In embodiments these two surfaces 3082, 3091 are sealed and thereby fixedly attached to one another, and methods known in the art can be used to create a seal between these two surfaces 3082, 3091, i.e., a seal between capsule-shell second body portion exterior surface 3082 and capsule-shell cap-portion interior surface 3091, thereby fixing capsule-shell second body portion 308 and capsule-shell cap portion 309 in their relative positions to each other. In additional embodiments (not shown in the Figs.), capsule-shell second body portion 308 and capsule-shell cap portion 309 are mechanically configured to interlock or snap into position with one another at a predetermined insertion depth of capsule-shell second body portion 308 into capsule-shell cap portion 309 and thereby fixedly attach capsule-shell second body portion 308 to capsule-shell cap portion 309.

Furthermore, the seal, pressure fit, or interlocking mechanical attachment: i) prevents contaminants from entering into second cavity 322, ii) prevents second fill composition 360, e.g., a polymer additive composition 380, from exiting second cavity 322, and iii) maintains the integrity of the capsule configuration as a single unit; in other words, the seal, pressure fit, or mechanical attachment mechanism prevents first capsule-shell second body portion 308 from separating from capsule-shell cap portion 309.

Amounts of fill compositions, i.e., first fill composition 350 and second fill composition 360 that are respectively first-fill-composition polymer additive 370 and second-fill-composition polymer additive 380, within each of the two inner cavities 320, 322 can be determined by persons of ordinary skill in the art without having to exercise undue experimentation and will necessarily be a function of each inner cavity's 320, 322 respective total volume of space.

In embodiments, capsule 302 has a first-cavity total volume of space 330 ranging from 1 to 100 milliliters and a second-cavity total volume of space 340 ranging from 1 to 100 milliliters. In embodiments, capsule 302 has a first-cavity total volume of space 330 ranging from 1 to 50 milliliters and a second-cavity total volume of space 340 ranging from 1 to 50 milliliters. In embodiments, capsule 302 has a first-cavity total volume of space 330 ranging from 1 to 10 milliliters and a second-cavity total volume of space 340 ranging from 1 to 10 milliliters. In embodiments, capsule 302 has a first-cavity total volume of space 330 ranging from 1 to 5 milliliters and a second-cavity total volume of space 340 ranging from 1 to 5 milliliters. In embodiments, capsule 302 has a first-cavity total volume of space 330 ranging from 0.1 to 2 milliliters and a second-cavity total volume of space 340 ranging from 0.1 to 2 milliliters. In embodiments, capsule 302 has a first-cavity total volume of space 330 that is less than 5 milliliters and a second-cavity total volume of space 340 that is less than 5 milliliters.

In embodiments, capsule 302 has longitudinal length 316 that is less than 100 centimeters. In embodiments, capsule 302 has longitudinal length 316 that is less than 20 centimeters. In embodiments, capsule 302 has longitudinal length 316 that is less than 10 centimeters. In embodiments, capsule 302 has longitudinal length 316 that is less than 5 centimeters. In embodiments, that greatest characteristic linear dimension 318 is longitudinal length 316, and the greatest characteristic linear dimension 318 of capsule 302 is the greatest linear length that can be measured as a characteristic dimension of capsule 302.

### Soft-Shell Configuration

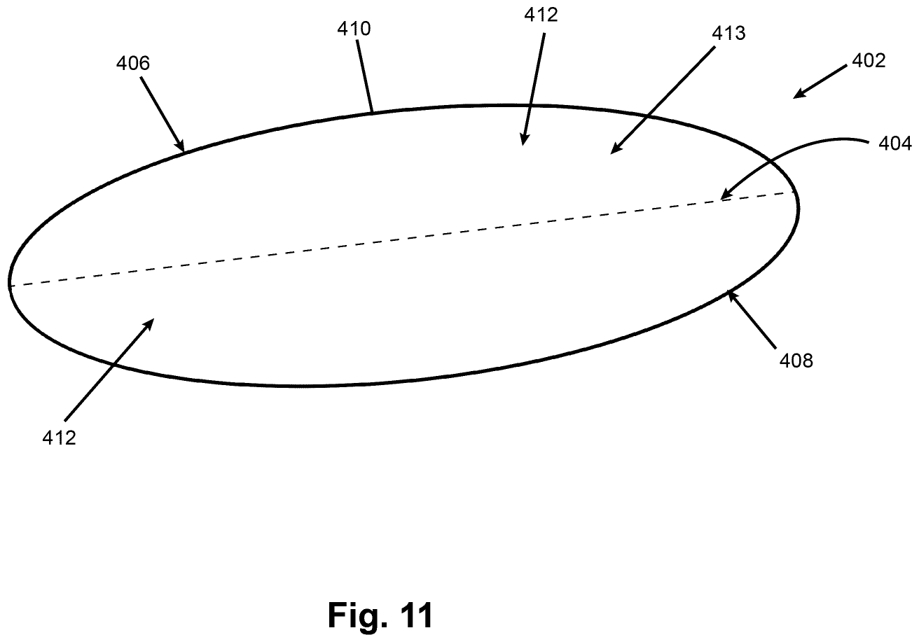

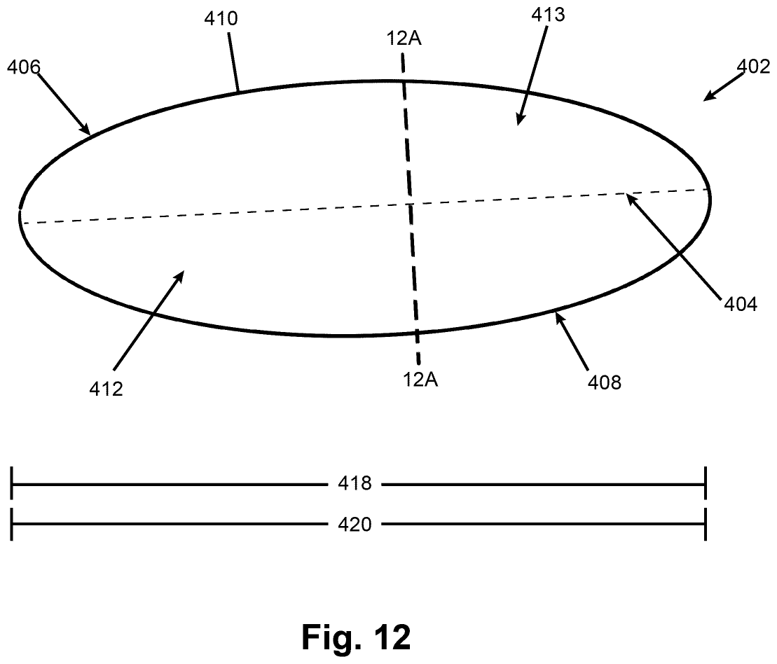

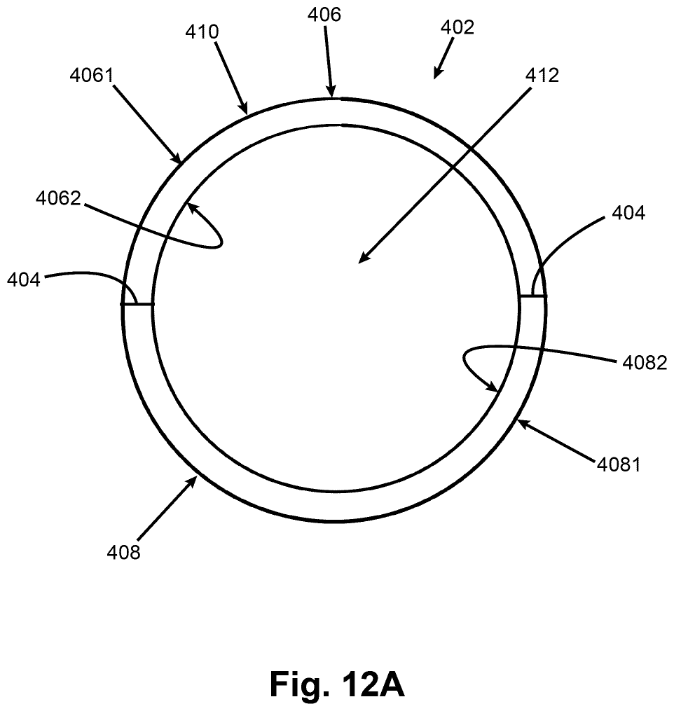

With reference to FIGS. 11-14, capsule 402 embodiments that employ a welded or seam-connected one-piece soft-shell configuration and one internal cavity 412, as shown in FIGS. 11-14, are manufactured using known methods have seam 404 that fixedly attaches the perimeter edge of first shell half 406 of soft shell 410 to the perimeter of second shell half 408 of soft shell 410. The interior surfaces 4062, 4082 respectively of first shell half 406 and second shell half 408 define the boundary or perimeter of the total volume of space of internal cavity 412 within soft shell 410.

It is seam 404 that: i) prevents contaminants from entering into soft-shell internal cavity 412, ii) prevents fill composition 414, e.g., a polymer additive composition 416, from exiting soft-shell cavity 412, and iii) maintains the integrity of the capsule configuration as a single unit; in other words, seam 404 prevents first half of the soft shell 406 and second half of the soft shell 408 from separating.

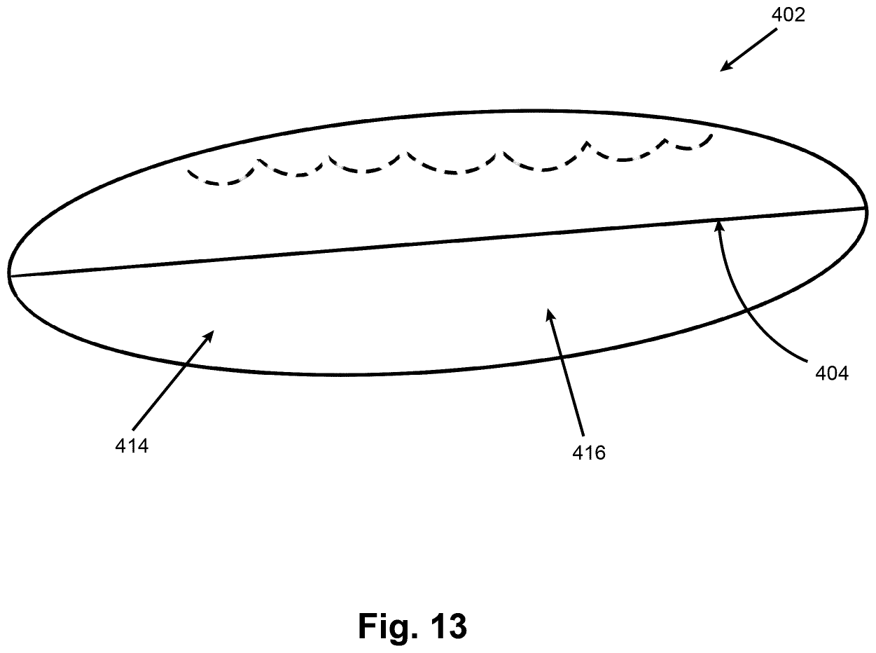

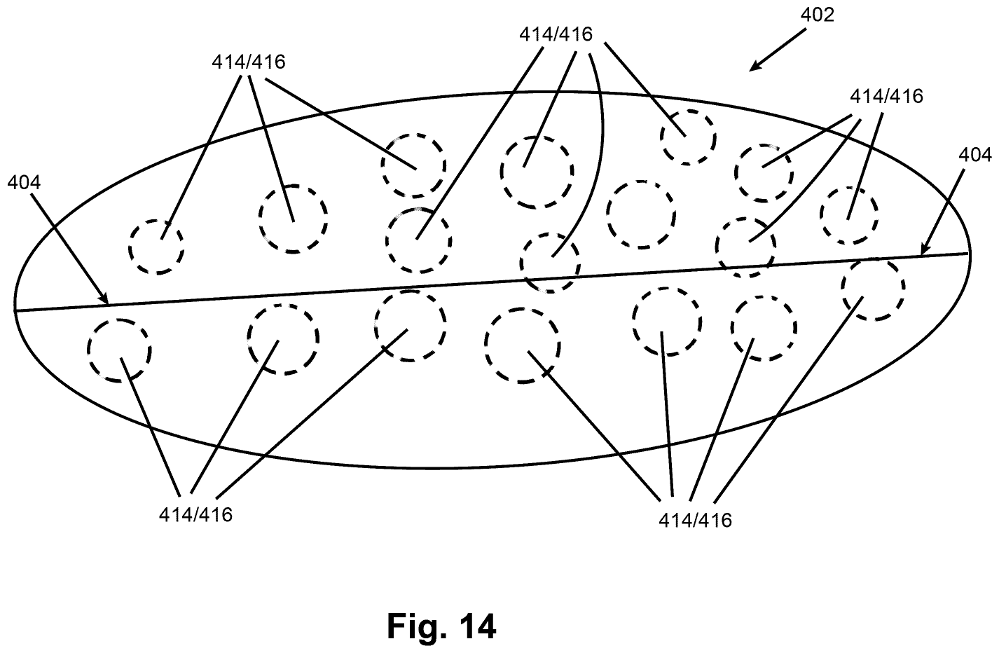

As shown in FIGS. 13, capsule 402 having a soft-shell configuration, can be filled with liquid fill material 414, e.g., a liquid polymer additive 416. Also, as shown in FIG. 14, capsule 402 having a soft-shell configuration, can be filled with solid fill material 414, e.g., a solid polymer additive 416.

The amount of liquid or solid polymer additive 416 within internal cavity 412 can be determined by a person of ordinary skill in the art without having to exercise undue experimentation and will necessarily be a function of a capsule's internal-cavity total volume of space 413.

In embodiments, capsule 402 has an internal-cavity total volume of space 413 ranging from 1 to 100 milliliters. In embodiments, capsule 402 has an internal-cavity total volume of space 413 ranging from 1 to 50 milliliters. In embodiments, capsule 402 has an internal-cavity total volume of space 413 ranging from 1 to 10 milliliters. In embodiments, capsule 402 has an internal-cavity total volume of space 413 ranging from 1 to 5 milliliters. In embodiments, capsule 402 has an internal-cavity total volume of space 413 ranging from 0.1 to 2 milliliters. In embodiments, capsule 402 has an internal-cavity total volume of space 413 that is less than 5 milliliters.

In embodiments, capsule 402 has longitudinal length 418 that is less than 100 centimeters. In embodiments, capsule 402 has longitudinal length 418 that is less than 20 centimeters. In embodiments, capsule 402 has longitudinal length 418 that is less than 10 centimeters. In embodiments, capsule 402 has longitudinal length 418 that is less than 5 centimeters. In embodiments, the greatest characteristic linear dimension 420 is longitudinal length 418, and the greatest characteristic linear dimension 420 is the greatest linear length that can be measured as a characteristic dimension of capsule 402.

### Useful Known Capsule Shells

Nonlimiting examples of useful capsule shells and capsule-shell configurations include those that are known to be manufactured or distributed by pharmaceutical companies or dietary-supplement companies. As non-limiting examples, useful capsule-shell configurations include: i) two-piece hard-shell configurations (sometimes referred to as two-piece hard-gelatin capsules) that have one internal cavity, ii) three-piece hard-shell configurations (sometimes referred to as three-piece hard-gelatin capsules) that have two internal cavities, and iii) soft-shell configurations (sometimes referred to as soft-gelatin capsules) that have one internal cavity. Non-limiting specific examples of these useful capsule-shell configurations are those capsule-shell configurations that are commonly used to encapsulate fish-oil dietary supplements for human consumption and capsule-shell configurations used to encapsulate headache and pain-relief medications for human consumption.

Compositions known to be useful for manufacturing capsule shells, e.g.: i) two-piece hard-shell configurations, ii) three-piece hard-shell configurations, and iii) soft-shell configurations, are well known, and any composition known to be useful for manufacturing capsule shells can be used to manufacture the capsule shell in the polymer-additive-filled capsule embodiments. Useful compositions for manufacturing capsule shells include hydroxy propyl methyl cellulose, methyl cellulose, polyvinyl alcohol, gelatin, denatured gelatin, starch, polyolefins, low density polyethylene (LDPE), linear low density polyethylene (LLDPE), high density polyethylene (HDPE), polypropylene (PP), polyesters, polybutylene terephthalate (PBT), polyethylene terephthalate (PET), polylactic acid, polyvinyl chloride (PVC), polycaprolactone, polyethylene glycol (PEG), acrylate polymers, polyacrylate, polymethyl acrylate, cellulose-acetate polymers, polycarbonates, polyamides, polystyrenes, acrylics, polyurethanes, alkyd resins, epoxy resins and combinations thereof.

Capsule-shell compositions that are used to manufacture capsule shells are well known and any of which can be employed to manufacture the polymer-additive-filled capsule embodiments.

In manufacturing any of the above-described two-piece, three-piece, or soft-shell capsule embodiments, known manufacturing methods for filling a capsule-shell cavity with a solid or liquid fill material can be employed to manufacture the polymer-additive-filled capsule embodiments. More specifically, known methods for filling a capsule cavity with a fill material, e.g., a polymer additive, in a two-piece hard-shell configuration, for filling both capsule cavities with one or more fill materials, e.g., a first polymer additive in a first cavity and a second polymer additive in a second cavity, in a three-piece hard-shell configuration, and filling a capsule cavity with a fill material, e.g., a polymer additive, in a soft-shell configuration, are all well known and can be employed to manufacture the polymer-additive-filled capsule embodiments.

Capsule embodiments are not limited to any particular shape or cross-sectional shape. Any known capsule shape useful for encapsulation can be used. Non-limiting examples include cross-sectional shapes that are: circle, circular, square, rectangular, and oval.

Capsule embodiments having hard-shell or soft-shell configurations can be manufactured using known machines and technologies without having to exercise undue experimentation.

Commercially available production equipment useful for manufacturing either hard-shell or soft-shell capsule configurations includes: dip-coating machines, rotary-die process machines, plate-process machines, reciprocating-die process machines, accogel capsule machines, and norton capsule machines.

### Polymer-Additive Pod Configuration

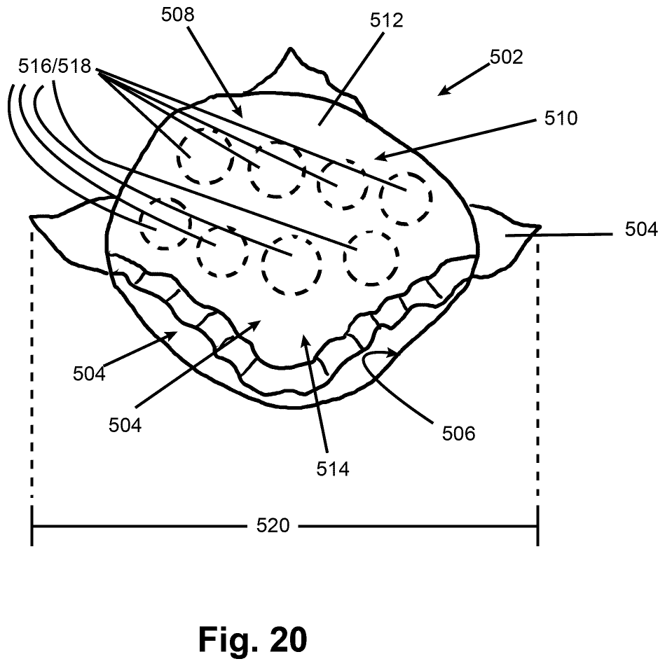

With reference to FIGS. 20-22, polymer-additive pod 502 embodiment can be understood as a sealed pouch or sealed pod 502 that has been manufactured from one or more polymeric films that make up pod skin 504. Sealed pod 502 has at least one enclosed internal cavity 510 that is filled with polymer-additive fill composition 516 that in embodiments is polymer additive 518.

As shown in FIG. 20, polymer-additive pod 502 has pod skin 504 that is the exterior surface 508 of pod 502 and encapsulates polymer fill composition 516, i.e., polymer additive 518 that is a solid or liquid polymer-additive composition.

Any known polymeric-film composition can be used as pod skin 504, and any known useful method for manufacturing a polymeric pod-skin and polymeric pod construction may be used; nonlimiting examples of films that are useful as pod skin 504 include blown films, cast films, and multilayer films. In embodiments, pod skin 504 is water soluble and in other embodiments pod skin 504 is not water soluble. Useful compositions for manufacturing pod skin 504 include hydroxy propyl methyl cellulose, methyl cellulose, polyvinyl alcohol, gelatin, denatured gelatin, starch, polyolefins, low density polyethylene (LDPE), linear low density polyethylene (LLDPE), high density polyethylene (HDPE), polypropylene (PP), polyesters, polybutylene terephthalate (PBT), polyethylene terephthalate (PET), polylactic acid, polyvinyl chloride (PVC), polycaprolactone, polyethylene glycol (PEG), acrylate polymers, polyacrylate, polymethyl acrylate, cellulose-acetate polymers, polycarbonates, polyamides, polystyrenes, acrylics, polyurethanes, alkyd resins, epoxy resins and combinations thereof.

The amount of liquid or solid polymer fill composition 516, e.g., polymer additive 518, within internal cavity 510 can be determined by a person of ordinary skill in the art without having to exercise undue experimentation and will necessarily be a function of a capsule's internal-cavity total volume of space 514.

In embodiments, polymer-additive pod 502 has an internal-cavity total volume of space 514 ranging from 1 to 100 milliliters. In embodiments, polymer-additive pod 502 has an internal-cavity total volume of space 514 ranging from 1 to 50 milliliters. In embodiments, polymer-additive pod 502 has an internal-cavity total volume of space 514 ranging from 1 to 10 milliliters. In embodiments, polymer-additive pod 502 has an internal-cavity total volume of space 514 ranging from 1 to 5 milliliters. In embodiments, polymer-additive pod 502 has an internal-cavity total volume of space 514 ranging from 0.1 to 2 milliliters. In embodiments, polymer-additive pod 502 has an internal-cavity total volume of space 514 that is less than 5 milliliters. In embodiments, polymer-additive pod 502 has an internal-cavity total volume of space 514 that is less than 10 milliliters. In embodiments, polymer-additive pod 502 has an internal-cavity total volume of space 514 that is less than 50 milliliters. In embodiments, polymer-additive pod 502 has an internal-cavity total volume of space 514 that is less than 100 milliliters.

In embodiments, polymer-additive pod 502 has a greatest characteristic linear dimension 520 that is less than 100 centimeters. In embodiments, polymer-additive pod 502 has a greatest characteristic linear dimension 520 that is less than 20 centimeters. In embodiments, polymer-additive pod 502 has a greatest characteristic linear dimension 520 that is less than 10 centimeters. In embodiments, polymer-additive pod 502 has a greatest characteristic linear dimension 520 that is less than 5 centimeters. The greatest characteristic linear dimension 520 of polymer-additive pod 502 is the greatest linear length that can be measured as a characteristic dimension 520 of capsule 502.

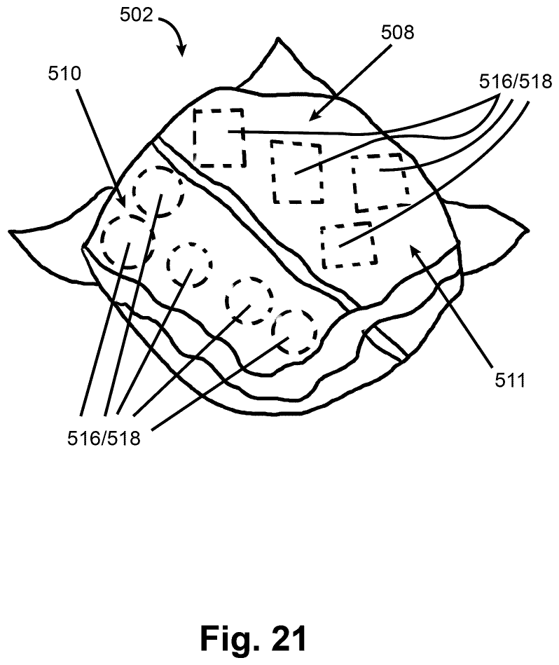

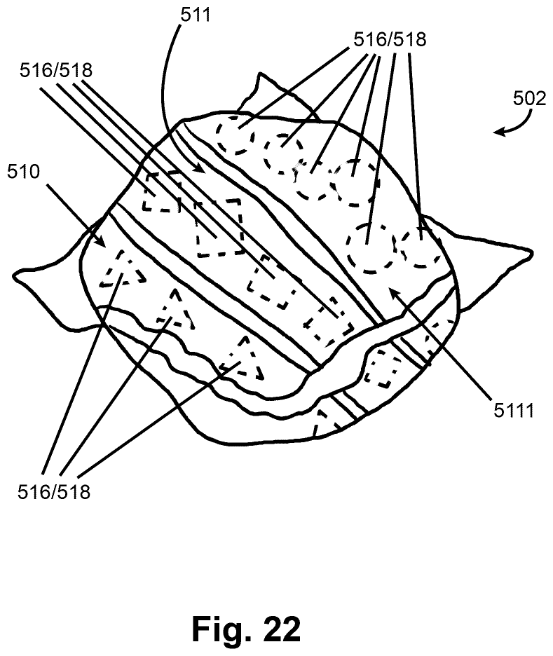

As shown in FIG. 21 and FIG. 22, in embodiments, polymer additive pod 502 has more than one internal cavity 510. In embodiments, polymer additive pod 502 has two internal cavities 510, 511 that are separated by a partition. In other embodiments, polymer additive pod 502 has three internal cavities 510, 511, and 5111 that are separated by partitions.

Polymer additive pod 502 can be manufactured using known machines and technologies without having to exercise undue experimentation. Commercially available production equipment useful for manufacturing polymer additive pod 502 includes: horizontal belt machine, rotary drum machine, and flatbed machine.

### Polymer Additives

Useful polymer additives include any known polymer additive-all of which are commercially available. Useful polymer additives can be solid, liquid, powder, blends of solids and liquids, dispersions, pastes, and slurries.

Nonlimiting examples of useful polymer additives include: a phosphite, a monophosphite, a hindered phenolic antioxidant, a hindered amine light stabilizer, a UV absorber, an acid neutralizer, an antiblocking agent, a thioester, a lubricant, an antistatic agent, a slip agent, a fire retardant, a nucleating agent, an impact modifier, a blowing agent, a plasticizer, a filler, a dye, a pigment, a polymer processing aid, or an optical brightener.

Another list of useful polymer additives includes: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid.

Additional useful polymer additives include:
i) Phosphites: bis(2,4-di-tert-butylphenyl) pentaerythritol diphosphite, distearylpentaerythritol diphosphite, P,P′-(Butylidenebis(2-(1,1-dimethylethyl)-5-methyl-4,1-phenylene)) bis(P,P-ditridecyl phosphite), poly(dipropyleneglycol) phenyl phosphite, and di-isodecyl paracumylphenol phosphite. Phosphites are commercially available under the tradenames: ULTRANOX 626, DP-S680, DP-LP09, DP-12, and DP-374.
ii) Monophosphites: 2,4-di-tert-butylphenyl)phosphite, tris(nonylphenyl) phosphite, di-phenyl isodecyl phosphite, reaction mass of: i) bis [2,4-bis(2-methylbutan-2-yl)phenyl]4-(2-methylbutan-2-yl)phenyl phosphite ii) 2,4-bis(2-methylbutan-2-yl)phenyl bis [4-(2-methylbutan-2-yl)phenyl]phosphite and iii) tris [4-(2-methylbutan-2-yl)phenyl]phosphite, and di-isodecyl phenyl phosphite. Monophosphites are commercially available under the tradenames: I-168, TNPP, DP-8, W705, and DP-7.
iii) Hindered phenolic antioxidants: octadecyl 3-(3,5-ditert-butyl-4-hydroxyphenyl) propionate, pentaerythritol tetrakis(3,5-di-tert-butyl-4-hydroxyhydrocinnamate), Tris(3,5-di-tert-butyl-4-hydroxybenzyl) isocyanurate, 1,3,5-tri (4-tert-butyl-2,6-dimethyl-3-hydroxybenzyl)-1,3,5-triazine-2,4,6 (1H,3H,5H)-trione, and 1,3,5-trimethyl-2,4,6-tris(3,5-di-tert-butyl-4-hydroxybenzyl)benzene. Hindered phenolic antioxidants are commercially available under the tradenames: I-1076, I-1010, 1-3114, CYANOX 1790, and I-1330.
iv) Hindered Amine Light Stabilizers: bis(2,2,6,6-tetramethyl-4-piperidyl) sebacate, 1-(2′-hydroxyethyl)-2,2,6,6-tetramethyl-4-hydroxy-piperidinylsuccinate, N,N′-bis(2,2,6,6-tetramethylpiperidin-4-yl) hexane-1,6-diamine; 2,4,6-trichloro-1,3,5-triazine; 2,4,4-trimethylpentan-2-amine, 1,6-hexanediamine,N1,N6-bis(2,2,6,6-tetramethyl-4-piperidinyl)-, polymer with2,4,6-trichloro-1,3,5-triazine, reaction products with, N-butyl-1-butanamine and N-butyl-2,2,6,6-tetramethyl-4-piperidinamine, and bis(1,2,2,6,6-pentamethyl-4-piperidyl) sebacate. Hindered Amine Light Stabilizers are commercially available under the tradenames: TINUVIN 770, TINUVIN 622, CHIMASORB 944, CHIMASORB 2020, and TINUVIN 765.
v) UV absorbers: 2-hydroxy-4-n-octyloxybenzophenone, 2 (2′-hydroxy-5′-methylphenyl)-benzotriazole, 2-(2′-Hydroxy-3′-tert-butyl-5′-methylphenyl)-5-chlorobenzotriazol, 2,4-di-tert-butyl-6-(5-chloro-2H-benzotriazol-2-yl) phenol, and oxybenzone. UV absorbers are commercially available under the tradenames: CHIMASORB 81, TINUVIN P, TINUVIN 326, TINUVIN 327, and CYASORB UV-9.
vi) Polymer catalyst scavengers: zinc oxide, zinc stearate, calcium stearate, hydrotalcite, and magnesium stearate.
vii) Anti-blocking agents: hydrated magnesium silicate, synthetic silicon dioxide, hydrated alumosilicates, natural silicon dioxide, calcium carbonate, and magnesium carbonate. Anti-blocking agents commercially available under the common names: talc, silica gel, zeolites, silica, and limestone.
viii) Thioesters: dilauryl thiodipropionate, distearyl thiodipropionate, dimyristal thiodipropionate, and dioctadecyl disulfide. Thioesters are commercially available under the tradenames: DLTDP, DSTDP, DMTDP, and HOSTANOX SE-10.
ix) Antistatic agents-glycerol monostearate, and glycerol monooleate.
x) Slip agents-oleamide, erucamide, stearamide, ethylene bis-stearamide, and stearyl erucamide.
xi) Fire retardants-chlorinated paraffins, red phosphorus, ammonium polyphosphate, aluminum trihydrate, and 9,10-dihydro-9-oxa-10-phosphaphenanthrene-10-oxide.
xii) Nucleating agents-dibenzylidenesorbitol, bis(p-methyl-dibenzylidene sorbitol), sodium bis 2,2′-methylene-bis-(4,6-di-tert-butyl-phenyl)phosphate, aluminum hydroxybis(4-(tert-butyl)benzoate); and bis(3,4-dimethylbenzylidene sorbitol). Nucleating agents being commercially available under the tradenames: IRGACLEAR D, IRGACLEAR DM, NA-11, SANDOSTAB 4030, and MILLAD 3988.
xiii) Impact modifiers-polymethyl methacrylate, ethylene vinyl acetate, ethylene-propylene-diene-monomer, and ethylene propylene rubber.
xiv) Blowing agents-azodicarbonamide, p-toluenesulfonylhydrazide, 4,4′-oxibis (Benzenesulfonylhydrazide), 5-phenyletrazole, and p-toluenesulfonylsemicarbazide
xv) Plasticizers-dioctyl terephthalate, diisononyl phthalate, tris(2-ethylhexyl) trimellitate, di-octyl adipate, Tris(2-ethylhexyl) phosphate, and mineral oil.
xvi) Polymer processing aids-polydimethyl siloxanes, fluoropolymers, polyethylene glycol, polycaprolactone, pentaerythritol tetrastearate, polyethylene wax, and oxidized polyethylene wax.

Additional monophosphite polymer additives include those additives having the following structure:

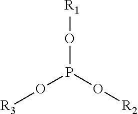

wherein R₁, R₂, and R₃ are independently selected, and
R₁, R₂, and R₅ are carbon-containing moieties.

More phosphite additives that are useful as polymer additives include phosphites having one of the following structures:

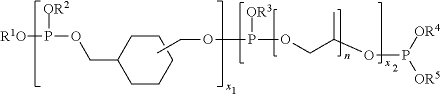

wherein
   each R¹, R², R³, R⁴ and R⁵ is independently selected and is a C₁₀-C₁₈ alkyl moiety,
   n is an integer ranging from 3 to 11, and
   the sum of x₁+x₂ is an integer ranging from 1-1000;
      or

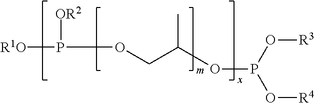

wherein
   each R¹, R², R³ and R⁴ is independently selected and is a C₁₀-C₁₈ alkyl moiety,
   m is an integer ranging from 3-11, and
   x is an integer ranging from 1-122;
      or

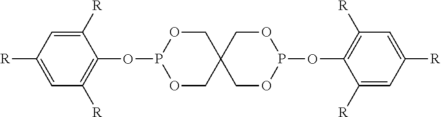

wherein
   each R is independently selected and is a C₁-C₂₀ alkyl moiety, a C₆-C₂₀ aryl moiety, C₆-C₂₀ alkylaryl moiety, a methyl moiety, a tertiary butyl moiety, a cumyl moiety, or a hydrogen atom.

All of the phosphites having any of the above structures can be obtained commercially or synthesized using known manufacturing methods.

Useful amounts of polymer additives in the polymer-additive-filled capsule embodiments can be determined by persons of ordinary skill in the art without having to exercise undue experimentation.

In order to introduce a specifically formulated amount of a polymer additive(s) into a polymer-compounding process, persons of ordinary skill in the art will be able to calculate a useful rate at which one or more of the polymer-additive-filled capsules or pods are introduced into a polymer compounding process using a simple mathematical calculation that is based upon an understanding of the amount of polymer additive within a single polymer-additive-filled capsule or pod. As a non-limiting example, if 400 grams of a specific polymer additive is required to be uniformly introduced into the feed throat of a single-screw extruder per 10 minutes (i.e., a uniform introduction rate of 40 grams per minute), and each polymer-additive-filled capsule holds 0.25 grams of the desired polymer additive, then 1600 polymer-additive-filled capsules will need to be uniformly introduced into the single-screw-extruder feed throat per 10 minutes (i.e., a uniform introduction rate of 160 polymer-additive-filled capsules per minute).

Manufacturing methods directed to introducing polymer additives into a polymer compounding process are well known, e.g., belt delivery systems are known to be useful for delivering a polymer additive into a feed throat of a single-screw extruder, and persons of ordinary skill in the art will be able to determine useful manufacturing methods for delivering polymer-additive-filled capsules or pods into a single-screw-extruder feed throat without having to exercise undue experimentation.

What is claimed is:

1. A capsule comprising:
a capsule shell having a capsule-shell composition;
the capsule shell having at least one interior surface and at least one exterior surface;
the at least one interior surface being a boundary of a first cavity within the capsule;
the first cavity having a first-cavity total volume of space;
a polymer-additive fill composition that occupies a portion of the first-cavity total volume of space;
the polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; and
the polymer-additive fill composition being a different composition than the capsule-shell composition.

2. The capsule of claim 1, wherein the polymer additive is: bis(2,4-di-tert-butylphenyl) pentaerythritol diphosphite; distearylpentaerythritol diphosphite; P,P′-(butylidenebis(2-(1,1-dimethylethyl)-5-methyl-4,1-phenylene)) bis(P,P-ditridecyl phosphite); poly(dipropyleneglycol) phenyl phosphite; di-isodecyl paracumylphenol phosphite; 2,4-di-tert-butylphenyl)phosphite; tris(nonylphenyl) phosphite; di-phenyl isodecyl phosphite; di-isodecyl phenyl phosphite; octadecyl 3-(3,5-ditert-butyl-4-hydroxyphenyl) propionate; pentaerythritol tetrakis(3,5-di-tert-butyl-4-hydroxyhydrocinnamate); tris(3,5-di-tert-butyl-4-hydroxybenzyl) isocyanurate; 1,3,5-tri (4-tert-butyl-2,6-dimethyl-3-hydroxybenzyl)-1,3,5-triazine-2,4,6 (1H,3H,5H)-trione; 1,3,5-trimethyl-2,4,6-tris(3,5-di-tert-butyl-4-hydroxybenzyl)benzene; bis(2,2,6,6-tetramethyl-4-piperidyl) sebacate; 1-(2′-hydroxyethyl)-2,2,6,6-tetramethyl-4-hydroxy-piperidinylsuccinate; N,N′-bis(2,2,6,6-tetramethylpiperidin-4-yl) hexane-1,6-diamine; 2,4,6-trichloro-1,3,5-triazine; 2,4,4-trimethylpentan-2-amine; 1,6-hexanediamine,N1,N6-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; bis(1,2,2,6,6-pentamethyl-4-piperidyl) sebacate; 2-hydroxy-4-n-octyloxybenzophenone; 2 (2′-hydroxy-5′-methylphenyl)-benzotriazole; 2-(2′-Hydroxy-3′-tert-butyl-5′-methylphenyl)-5-chlorobenzotriazol; 2,4-di-tert-butyl-6-(5-chloro-2H-benzotriazol-2-yl) phenol; oxybenzone; zinc oxide; zinc stearate; calcium stearate; hydrotalcite; magnesium stearate; hydrated magnesium silicate; synthetic silicon dioxide; hydrated alumosilicates; natural silicon dioxide; calcium carbonate; magnesium carbonate; dilauryl thiodipropionate; distearyl thiodipropionate; dimyristal thiodipropionate; dioctadecyl disulfide; glycerol monostearate; glycerol monooleate; oleamide; erucamide; stearamide; ethylene bis-stearamide; stearyl erucamide; chlorinated paraffins; red phosphorus; ammonium polyphosphate; aluminum trihydrate; 9,10-dihydro-9-oxa-10-phosphaphenanthrene-10-oxide; dibenzylidenesorbitol; bis(p-methyl-dibenzylidene sorbitol); sodium bis 2,2′-methylene-bis-(4,6-di-tert-butyl-phenyl)phosphate; aluminum hydroxybis(4-(tert-butyl)benzoate); bis(3,4-dimethylbenzylidene sorbitol); polymethyl methacrylate; ethylene vinyl acetate; ethylene-propylene-diene-monomer; ethylene propylene rubber; azodicarbonamide; p-toluenesulfonylhydrazide; 4,4′-oxibis(benzenesulfonylhydrazide); 5-phenyletrazole; p-toluenesulfonylsemicarbazide; dioctyl terephthalate; diisononyl phthalate; tris(2-ethylhexyl) trimellitate; di-octyl adipate; tris(2-ethylhexyl) phosphate; mineral oil; polydimethyl siloxanes; fluoropolymers; polyethylene glycol; polycaprolactone; pentaerythritol tetrastearate; polyethylene wax; or oxidized polyethylene wax.

3. The capsule of claim 1, wherein the polymer additive is a phosphite having one of the following structures: 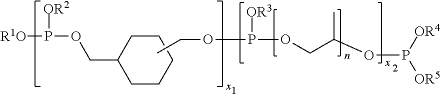
wherein
each R¹, R², R³, R⁴ and R⁵ is independently selected and is a C₁₀-C₁₈ alkyl moiety,
n is an integer ranging from 3 to 11, and
the sum of x₁+x₂ is an integer ranging from 1-1000;
or 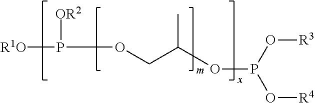
wherein
each R¹, R², R³ and R⁴ is independently selected and is a C₁₀-C₁₈ alkyl moiety,
m is an integer ranging from 3-11, and
x is an integer ranging from 1-122;
or 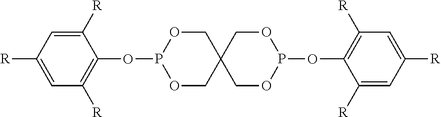
wherein
each R is independently selected and is a C₁-C₂₀ alkyl moiety, a C₆-C₂₀ aryl moiety, C₆-C₂₀ alkylaryl moiety, a methyl moiety, a tertiary butyl moiety, a cumyl moiety, or a hydrogen atom.

4. The capsule of claim 1, wherein the first-cavity total volume of space is less than 5 milliliters.

5. The capsule of claim 1, wherein the first-cavity total volume of space ranges from 0.1 to 2.0 milliliters.

6. The capsule of claim 1, wherein the fill composition is a liquid.

7. The capsule of claim 1, wherein the fill composition is a solid.

8. The capsule of claim 1, wherein the capsule shell has a capsule-shell body portion and a capsule-shell cap portion.

9. The capsule of claim 1, wherein the longitudinal length of the capsule is less than 5 centimeters.

10. The capsule of claim 1, wherein the greatest characteristic linear dimension of the capsule is less than 5 centimeters.

11. A method comprising the step of introducing the capsule of claim 1 into a polymer-compounding process.

12. A capsule comprising:
a capsule shell having a capsule-shell composition;
the capsule shell having a first interior surface, a second interior surface, and at least one exterior surface;
the first interior surface being a boundary of a first cavity within the capsule;
the second interior surface being a boundary of a second cavity within the capsule;
the first cavity having a first-cavity total volume of space;
the second cavity having a second-cavity total volume of space;
a first polymer-additive fill composition that occupies at least a portion of the first-cavity total volume of space;
a second polymer-additive fill composition that occupies at least a portion of the second-cavity total volume of space;
the first polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid;
the second polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid;
the first polymer-additive fill composition being a different polymer additive than the second polymer-additive fill composition; and
the first polymer-additive fill composition and the second polymer-additive fill composition being different compositions than the capsule-shell composition.

13. The capsule of claim 12, wherein the first polymer-additive fill composition includes a polymer additive that is: bis(2,4-di-tert-butylphenyl) pentaerythritol diphosphite; distearylpentaerythritol diphosphite; P,P′-(butylidenebis(2-(1,1-dimethylethyl)-5-methyl-4,1-phenylene)) bis(P,P-ditridecyl phosphite); poly(dipropyleneglycol) phenyl phosphite; di-isodecyl paracumylphenol phosphite; 2,4-di-tert-butylphenyl)phosphite; tris(nonylphenyl)phosphite; di-phenyl isodecyl phosphite; di-isodecyl phenyl phosphite; octadecyl 3-(3,5-ditert-butyl-4-hydroxyphenyl) propionate; pentaerythritol tetrakis(3,5-di-tert-butyl-4-hydroxyhydrocinnamate); tris(3,5-di-tert-butyl-4-hydroxybenzyl) isocyanurate; 1,3,5-tri (4-tert-butyl-2,6-dimethyl-3-hydroxybenzyl)-1,3,5-triazine-2,4,6 (1H,3H,5H)-trione; 1,3,5-trimethyl-2,4,6-tris(3,5-di-tert-butyl-4-hydroxybenzyl)benzene; bis(2,2,6,6-tetramethyl-4-piperidyl) sebacate; 1-(2′-hydroxyethyl)-2,2,6,6-tetramethyl-4-hydroxy-piperidinylsuccinate; N,N′-bis(2,2,6,6-tetramethylpiperidin-4-yl) hexane-1,6-diamine; 2,4,6-trichloro-1,3,5-triazine; 2,4,4-trimethylpentan-2-amine; 1,6-hexanediamine,N1,N6-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; bis(1,2,2,6,6-pentamethyl-4-piperidyl) sebacate; 2-hydroxy-4-n-octyloxybenzophenone; 2 (2′-hydroxy-5′-methylphenyl)-benzotriazole; 2-(2′-Hydroxy-3′-tert-butyl-5′-methylphenyl)-5-chlorobenzotriazol; 2,4-di-tert-butyl-6-(5-chloro-2H-benzotriazol-2-yl) phenol; oxybenzone; zinc oxide; zinc stearate; calcium stearate; hydrotalcite; magnesium stearate; hydrated magnesium silicate; synthetic silicon dioxide; hydrated alumosilicates; natural silicon dioxide; calcium carbonate; magnesium carbonate; dilauryl thiodipropionate; distearyl thiodipropionate; dimyristal thiodipropionate; dioctadecyl disulfide; glycerol monostearate; glycerol monooleate; oleamide; erucamide; stearamide; ethylene bis-stearamide; stearyl erucamide; chlorinated paraffins; red phosphorus; ammonium polyphosphate; aluminum trihydrate; 9,10-dihydro-9-oxa-10-phosphaphenanthrene-10-oxide; dibenzylidenesorbitol, bis(p-methyl-dibenzylidene sorbitol); sodium bis 2,2′-methylene-bis-(4,6-di-tert-butyl-phenyl)phosphate; aluminum hydroxybis(4-(tert-butyl)benzoate) bis(3,4-dimethyl-benzylidene sorbitol); polymethyl methacrylate; ethylene vinyl acetate; ethylene-propylene-diene-monomer; ethylene propylene rubber; azodicarbonamide; p-toluenesulfonylhydrazide; 4,4′-oxibis(benzenesulfonylhydrazide); 5-phenyletrazole; p-toluenesulfonylsemicarbazide; dioctyl terephthalate; diisononyl phthalate; tris(2-ethylhexyl) trimellitate; di-octyl adipate; tris(2-ethylhexyl) phosphate; mineral oil; polydimethyl siloxanes; fluoropolymers; polyethylene glycol; polycaprolactone; pentaerythritol tetrastearate; polyethylene wax; or oxidized polyethylene wax.

14. The capsule of claim 12, wherein the second polymer-additive fill composition includes a polymer additive that is: bis(2,4-di-tert-butylphenyl) pentaerythritol diphosphite; distearylpentaerythritol diphosphite; P,P′-(butylidenebis(2-(1,1-dimethylethyl)-5-methyl-4,1-phenylene)) bis(P,P-ditridecyl phosphite); poly(dipropyleneglycol) phenyl phosphite; di-isodecyl paracumylphenol phosphite; 2,4-di-tert-butylphenyl)phosphite; tris(nonylphenyl) phosphite; di-phenyl isodecyl phosphite; di-isodecyl phenyl phosphite; octadecyl 3-(3,5-ditert-butyl-4-hydroxyphenyl) propionate; pentaerythritol tetrakis(3,5-di-tert-butyl-4-hydroxyhydrocinnamate); tris(3,5-di-tert-butyl-4-hydroxybenzyl) isocyanurate; 1,3,5-tri (4-tert-butyl-2,6-dimethyl-3-hydroxybenzyl)-1,3,5-triazine-2,4,6 (1H,3H,5H)-trione; 1,3,5-trimethyl-2,4,6-tris(3,5-di-tert-butyl-4-hydroxybenzyl)benzene; bis(2,2,6,6-tetramethyl-4-piperidyl) sebacate; 1-(2′-hydroxyethyl)-2,2,6,6-tetramethyl-4-hydroxy-piperidinylsuccinate; N,N′-bis(2,2,6,6-tetramethylpiperidin-4-yl) hexane-1,6-diamine; 2,4,6-trichloro-1,3,5-triazine; 2,4,4-trimethylpentan-2-amine; 1,6-hexanediamine,N1,N6-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; bis(1,2,2,6,6-pentamethyl-4-piperidyl) sebacate; 2-hydroxy-4-n-octyloxybenzophenone; 2 (2′-hydroxy-5′-methylphenyl)-benzotriazole; 2-(2′-Hydroxy-3′-tert-butyl-5′-methylphenyl)-5-chlorobenzotriazol; 2,4-di-tert-butyl-6-(5-chloro-2H-benzotriazol-2-yl) phenol; oxybenzone; zinc oxide; zinc stearate; calcium stearate; hydrotalcite; magnesium stearate; hydrated magnesium silicate; synthetic silicon dioxide; hydrated alumosilicates; natural silicon dioxide; calcium carbonate; magnesium carbonate; dilauryl thiodipropionate; distearyl thiodipropionate; dimyristal thiodipropionate; dioctadecyl disulfide; glycerol monostearate; glycerol monooleate; oleamide; erucamide; stearamide; ethylene bis-stearamide; stearyl erucamide; chlorinated paraffins; red phosphorus; ammonium polyphosphate; aluminum trihydrate; 9,10-dihydro-9-oxa-10-phosphaphenanthrene-10-oxide; dibenzylidenesorbitol, bis(p-methyl-dibenzylidene sorbitol); sodium bis 2,2′-methylene-bis-(4,6-di-tert-butyl-phenyl)phosphate; aluminum hydroxybis(4-(tert-butyl)benzoate); bis(3,4-dimethyl-benzylidene sorbitol); polymethyl methacrylate; ethylene vinyl acetate; ethylene-propylene-diene-monomer; ethylene propylene rubber; azodicarbonamide; p-toluenesulfonylhydrazide; 4,4′-oxibis(benzenesulfonylhydrazide); 5-phenyletrazole; p-toluenesulfonylsemicarbazide; dioctyl terephthalate; diisononyl phthalate; tris(2-ethylhexyl) trimellitate; di-octyl adipate; tris(2-ethylhexyl) phosphate; mineral oil; polydimethyl siloxanes; fluoropolymers; polyethylene glycol; polycaprolactone; pentaerythritol tetrastearate; polyethylene wax; or oxidized polyethylene wax.

15. The capsule of claim 12, wherein the first fill composition or the second fill composition includes a polymer additive that is a phosphite having one of the following structures: 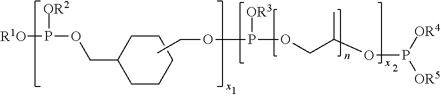
wherein
each R¹, R², R³, R⁴ and R⁵ is independently selected and is a C₁₀-C₁₈ alkyl moiety,
n is an integer ranging from 3 to 11, and
the sum of x₁+x₂ is an integer ranging from 1-1000;
or 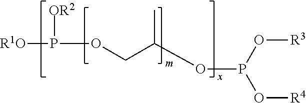
wherein
each R¹, R², R³ and R⁴ is independently selected and is a C₁₀-C₁₈ alkyl moiety,
m is an integer ranging from 3-11, and
x is an integer ranging from 1-122;
or 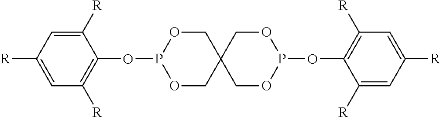
wherein
each R is independently selected and is a C₁-C₂₀ alkyl moiety, a C₆-C₂₀ aryl moiety, C₆-C₂₀ alkylaryl moiety, a methyl moiety, a tertiary butyl moiety, a cumyl moiety, or a hydrogen atom.

16. The capsule of claim 12, wherein the first-cavity total volume of space is less than 5 milliliters and the second-cavity total volume of space is less than 5 milliliters.

17. The capsule of claim 12, wherein the first fill composition is a liquid and the second fill composition is a liquid.

18. The capsule of claim 12, wherein the first fill composition is a liquid and the second fill composition is a solid.

19. The capsule of claim 12, wherein the first fill composition is a solid and the second fill composition is a solid.

20. The capsule of claim 12, wherein the capsule shell has a body portion, a first cap portion, and a second cap portion.

21. The capsule of claim 12, wherein the longitudinal length of the capsule is less than 5 centimeters.

22. The capsule of claim 12, wherein the greatest characteristic linear dimension of the capsule is less than 5 centimeters.

23. A method comprising the step of introducing the capsule of claim 12 into a polymer-compounding process.

24. A polymer-additive pod comprising:
a pod skin that is at least one polymeric film manufactured from a polymeric-film composition;
the pod skin having at least one interior surface and at least one exterior surface;
the pod-skin interior surface being a boundary of an internal first cavity that is enclosed within the polymer-additive pod;
the first cavity having a total volume of space;
a polymer-additive fill composition that occupies a portion of the first-cavity total volume of space;
the polymer-additive fill composition including a polymer additive that is: a phosphite, a monophosphite, a hindered phenolic antioxidant, a hindered amine light stabilizer, a UV absorber, an antiblocking agent, a thioester, an antistatic agent, a slip agent, a fire retardant, a nucleating agent, an impact modifier, a blowing agent, a plasticizer, or a polymer processing aid; and
the polymer-additive fill composition being a different composition than the polymeric-film composition.

25. The polymer-additive pod of claim 24, wherein the polymer additive is: bis(2,4-di-tert-butylphenyl) pentaerythritol diphosphite; distearylpentaerythritol diphosphite; P,P′-(butylidenebis(2-(1,1-dimethylethyl)-5-methyl-4,1-phenylene)) bis(P,P-ditridecyl phosphite); poly(dipropyleneglycol) phenyl phosphite; di-isodecyl paracumylphenol phosphite; 2,4-di-tert-butylphenyl)phosphite; tris(nonylphenyl) phosphite; di-phenyl isodecyl phosphite; di-isodecyl phenyl phosphite; octadecyl 3-(3,5-ditert-butyl-4-hydroxyphenyl) propionate; pentaerythritol tetrakis(3,5-di-tert-butyl-4-hydroxyhydrocinnamate); tris(3,5-di-tert-butyl-4-hydroxybenzyl) isocyanurate; 1,3,5-tri (4-tert-butyl-2,6-dimethyl-3-hydroxybenzyl)-1,3,5-triazine-2,4,6 (1H,3H,5H)-trione; 1,3,5-trimethyl-2,4,6-tris(3,5-di-tert-butyl-4-hydroxybenzyl)benzene; bis(2,2,6,6-tetramethyl-4-piperidyl) sebacate; 1-(2′-hydroxyethyl)-2,2,6,6-tetramethyl-4-hydroxy-piperidinylsuccinate; N,N′-bis(2,2,6,6-tetramethylpiperidin-4-yl) hexane-1,6-diamine; 2,4,6-trichloro-1,3,5-triazine; 2,4,4-trimethylpentan-2-amine; 1,6-hexanediamine,N1,N6-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; bis(1,2,2,6,6-pentamethyl-4-piperidyl) sebacate; 2-hydroxy-4-n-octyloxybenzophenone; 2 (2′-hydroxy-5′-methylphenyl)-benzotriazole; 2-(2′-Hydroxy-3′-tert-butyl-5′-methylphenyl)-5-chlorobenzotriazol; 2,4-di-tert-butyl-6-(5-chloro-2H-benzotriazol-2-yl) phenol; oxybenzone; zinc oxide; zinc stearate; calcium stearate; hydrotalcite; magnesium stearate; hydrated magnesium silicate; synthetic silicon dioxide; hydrated alumosilicates; natural silicon dioxide; calcium carbonate; magnesium carbonate; dilauryl thiodipropionate; distearyl thiodipropionate; dimyristal thiodipropionate; dioctadecyl disulfide; glycerol monostearate; glycerol monooleate; oleamide; erucamide; stearamide; ethylene bis-stearamide; stearyl erucamide; chlorinated paraffins; red phosphorus; ammonium polyphosphate; aluminum trihydrate; 9,10-dihydro-9-oxa-10-phosphaphenanthrene-10-oxide; dibenzylidenesorbitol, bis(p-methyl-dibenzylidene sorbitol); sodium bis 2,2′-methylene-bis-(4,6-di-tert-butyl-phenyl)phosphate; aluminum hydroxybis(4-(tert-butyl)benzoate); bis(3,4-dimethyl-benzylidene sorbitol); polymethyl methacrylate; ethylene vinyl acetate; ethylene-propylene-diene-monomer; ethylene propylene rubber; azodicarbonamide; p-toluenesulfonylhydrazide; 4,4′-oxibis(benzenesulfonylhydrazide); 5-phenyletrazole; p-toluenesulfonylsemicarbazide; dioctyl terephthalate; diisononyl phthalate; tris(2-ethylhexyl) trimellitate; di-octyl adipate; tris(2-ethylhexyl) phosphate; mineral oil; polydimethyl siloxanes; fluoropolymers; polyethylene glycol; polycaprolactone; pentaerythritol tetrastearate; polyethylene wax; or oxidized polyethylene wax.

26. The polymer-additive pod of claim 24, wherein the polymer-additive fill composition includes a polymer additive that is a phosphite having one of the following structures: 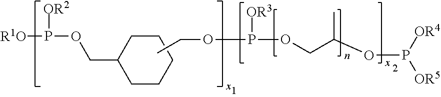
wherein
each R¹, R², R³, R⁴ and R⁵ is independently selected and is a C₁₀-C₁₈ alkyl moiety,
n is an integer ranging from 3 to 11, and
the sum of x₁+x₂ is an integer ranging from 1-1000;
or 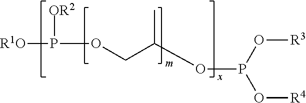
wherein
each R¹, R², R³ and R⁴ is independently selected and is a C₁₀-C₁₈ alkyl moiety,
m is an integer ranging from 3-11, and
x is an integer ranging from 1-122;
or 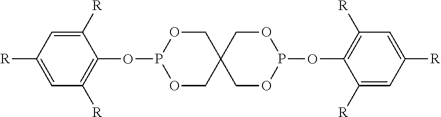
wherein
each R is independently selected and is a C₁-C₂₀ alkyl moiety, a C₆-C₂₀ aryl moiety, C₆-C₂₀ alkylaryl moiety, a methyl moiety, a tertiary butyl moiety, a cumyl moiety, or a hydrogen atom.

27. The polymer-additive pod of claim 24, wherein the first-cavity total volume of space is less than 10 milliliters.

28. The polymer-additive pod of claim 24, wherein the polymer-additive fill composition is a liquid-phase composition.

29. The polymer-additive pod of claim 24, wherein the polymer-additive fill composition is a solid-phase composition.

30. The polymer-additive pod of claim 24, wherein the greatest characteristic linear dimension of the polymer-additive pod is less than 10 centimeters.

31. The polymer-additive pod of claim 24, further comprising an internal second cavity that is enclosed within the polymer-additive pod.

32. The polymer-additive pod of claim 24, further comprising an internal second cavity that is enclosed within the polymer-additive pod; and
an internal third cavity that is enclosed within the polymer-additive pod.

33. A method comprising the step of introducing the polymer-additive pod of claim 24 into a polymer-compounding process.
